(19) United States
(12) Patent Application Publication
(10) Pub. No.: US 2006/0044109 A1
(43) Pub. Date: Mar. 2, 2006

(54) Identification and selection of keys for use with locks

(76) Inventors: John Philip Griffits, Tallai (AU); Yvonne Sylvia Griffits, Tallai (AU)

Correspondence Address: BROOKS KUSHMAN P.C., 1000 TOWN CENTER, TWENTY-SECOND FLOOR, SOUTHFIELD, MI, 48075, US

(21) Appl. No.: 10/524,333

(22) PCT Filed: Aug. 14, 2003
(86) PCT No.: PCT/AU03/01029

§ 371 Date: Feb. 11, 2005

(30) Foreign Application Priority Data
Aug. 14, 2002 (AU) 2002950762

(51) Int. Cl. G05B 19/00

(52) U.S. Cl. 340/5.65; 340/10.1

(57) ABSTRACT

The present invention describes a method for coupling electronically addressable and readable illumination means to one at least lock keys. Said illumination means may be used to identify key function and to select a particular key from a group of keys on a key grouping means (eg key ring). A novel key ring is described that may deliver power and electronic signals via conductor means to one at least keys. The system is controlled by a key control means that is preferably provided in a key tag format. The invention provides scope to couple other electronic devices and functions to a key ring. A method of automatically attaching/detaching keys from a key ring is also described.

### DESCRIPTION OF THE INVENTION

The use of key(s) to action a lock means is in widespread use. The average person usually has or has access to a plurality of keys. One at least keys in said plurality may serve a different function to one at least other keys (eg the first may unlock the front door of the house, the second the garage door).
As a non-limiting example, said plural keys may be organised by a Key Grouping Means is (KGM). A key ring is preferably a non-limiting example of a Key Grouping Means.

Whether grouped with one at least other keys (eg. on a KGM) or a key by itself (as a non-limiting example on a KGM and/or lying on a table top), it may be difficult using known art means to identify the function of the key:—eg. what lock(s) it is intended to action. This task may be made all the more difficult if, as non-limiting examples:—a) there are plural keys of similar appearance; and/or b) the light levels are low (eg night); and/or c) it has been some time since the key was used (eg one may be cleaning out a drawer and locate a key that one has no idea of which lock(s) it may action).
A non-limiting objective of the present invention preferably includes a means to determine the lock(s) that one at least keys may action. Said identification means preferably includes automated and/or electronic means.
A non-limiting objective of the present invention preferably includes a means to identify one at least locks. Said means to identify locks preferably includes automated and/or electronic means.
A non-limiting objective of the present invention preferably includes a means to select from a plurality of keys (eg on a key ring) one at least keys that may action one at least locks. Said selection means preferably includes automated and/or electronic means. The invention preferably allows that only one key may be on the key grouping means (eg key ring). The invention preferably allows that none of the keys on the Key Grouping Means (KGM) may action a target lock.
A non-limiting objective of the present invention preferably couples a means to facilitate insertion of the key in its target lock. Said insertion facilitation means preferably includes an illumination means. Said illumination means is preferably coupled to the key selection means.
A non-limiting objective of the present invention preferably includes a means to transfer Lock ID information from a lock that one may want to action, to a Key ID and/or Key Selection Means. Said means preferably includes automated and/or electronic means.
A non-limiting objective of the present invention preferably includes a means to use said transferred Lock ID information to facilitate selection of the key(s) that may action said lock.

The use of the term non-volatile memory storage elements in this document preferably may include, as non-limiting examples, one at least of:—Flash Memory, EEPROM, EPROM, Laser Programmed ROM, Mask ROM, Battery Backed RAM (eg SRAM, DRAM).

The term key in this specification preferably applies to means used to lock and/or unlock, mechanical and/or electronic locks. Said means preferably includes a physical device. Said means preferably includes mechanical and/or electronic means.

The part of the key that is usually inserted into a lock is preferably referenced as the key shaft in this document. Said shaft preferably has a top edge and a bottom edge and two faces. It is preferable that the number of surfaces on a key handle and/or shaft is not limited.

In this document, the key edge that includes the serration's (teeth) cut into it is preferably referenced as the bottom edge, as a non-limiting example. Double sided keys preferably may have serration's on both the top and bottom edge. The invention preferably allows for one at least keys to be cut in any pattern and/or on any number of surfaces and/or edges of the key.

The part of the key that is usually grasped by the user when locking/unlocking a lock is preferably referenced as the key handle or more simply the handle. In the known art the key handle usually also provides a means to facilitate coupling of the key to a Key Grouping Means (eg. key ring), with the usual means including a hole in the handle of the key.

Where permitted by the context of usage in this specification, the terms action(s) and/or actioned preferably refers, in part at least, to locking and/or unlocking one at least locks.

The use of the term RF Wireless Communication in this specification preferably may be read as referring to Bluetooth and/or Zigbee and/or 802.11 means as non-limiting examples.

Reference to the term remote undressing means preferably includes those means described in copending PCT/AU03/00769 by the present inventors titled ‘Garments that automatically disrobe in response to remote control means’ that is incorporated by reference.

Parts of the invention may be described with reference to a single key and/or single LKM and/or a single lock, however, it must be understood that the invention preferably allows for said key to action plural locks and/or for said lock to be actioned by plural keys. Furthermore it is preferable that the number and/or type of keys and/or LKM's that the invention may be applied to is not limited. It is also preferable that the number of locks that the invention may be applied to is not limited. The invention preferably allows that part at least means described for implementation in a local key means may be implemented in part at least in the KGM and/or KCM and/or other means. The invention preferably allows that part at least means described for implementation in a KGM may be implemented in part at least in the local key means and/or KCM, and/or other means. The invention preferably allows that part at least means described for implementation in a KCM may be implemented in part at least in the KGM and/or local key means, and/or other means.

A non-limiting objective of the present invention seeks to describe a means to apply automated and/or electronic means to facilitate:—
i) identifying the function of one at least keys; and/or
ii) selection of one at least keys for use with one at least locks; and/or
iii) insertion of one at least keys in one at least locks.

Local Key Means (LKM). The preferred embodiment includes the coupling of electronic and/or mechanical means referenced as a Local Key Means (LKM) to one at least keys to provide an electronic address means and/or electronically readable ID means to said key(s), as well as providing a LED (or other illumination means) that may be used to facilitate selection and/or use of said key(s). It is preferable that one at least locks are coupled to one at least Lock ID Means that may be read automatically by means coupled to the invention. One at least said locks preferably may be actioned by one at least keys using means of the present invention.

In the preferred embodiment(s) one at least LKM's preferably receive power from a power means that may supply plural LKM's. Said supply is preferably via electrical conductors and preferably derives from a power means that is coupled to other means (eg Key Grouping Means and/or Key Control Means). The invention preferably allows that part at least of the power means of one at least LKM's may be from means coupled directly to said LKM (eg battery (rechargeable and/or non-rechargeable), and/or solar cells (that preferably may be powered from illumination means eg LED coupled to KCM/KGM) and/or capacitor). The transfer of data and/or control means between one at least LKM and other means (eg Key Grouping Means and/or Key Control Means) is preferably via electrical conductor means. The invention preferably allows that said transfer means are not limited. Non-limiting examples of said transfer means preferably include one at least of:—i) electrical conductors; ii) optical conductors; iii) wireless using infrared means (eg IrDa); iv) RF Wireless Communication.

Key Grouping Means (KGM). One non-limiting preferred embodiment of the invention includes a Key Grouping Means (KGM) to collate one at least keys (as do known art KGM's eg key ring means), wherein said KGM preferably maintains the ability of keys to rotate under gravity away from a manually selected key (as is the case with known art key rings) while preferably providing a means for a) power and/or b) data and/or control information (preferably in digital format) to be transferred between a) one at least LKM(s) and b) one at least KGM(s) and/or KCM(s). It is preferable that one at least keys may be removeably attached to said KGM. A non-limiting preferred embodiment of the invention includes an LKM Socket Means coupled to one at least LKM's that may mate with a KGM Plug Means attached (preferably by resilient and/or flexible cable that includes electrically conducting means) to said KGM. It is preferable that one at least keys may be attached and/or detached using automated and/or electronic means. A preferred automated means is to include a micro-motor (preferably using Shaped Metal Alloys eg Nitinol wire) within said LKM to release one at least retaining means between said plug and socket. In embodiments where the power means to said LKM are delivered from said KGM this arrangement may allow the automated detachment of LKM's however, there may not be a power source to permit the automated attachment of said LKM to a KGM. In this embodiment it is preferable that said retaining means is shaped to facilitate manual insertion of said plug into said socket such that attachment is simply a matter of pushing said socket and plug together and detachment is preferably by user command (eg a keystroke and/or voice command and/or display menu selection). An alternative embodiment preferably includes said micro-motor in one at least KGM Plug Means preferably permitting automated attachment and detachment.
The invention preferably allows for automated and/or electronic means for attaching and/or removing one at least keys from/to a key attachment means that is and/or may be coupled to i) a single key and/or ii) plural keys. A non-limiting example of said key attachment means is preferably a key ring.
The invention preferably allows for manual means to attach and/or detach one at least keys from/to a key attachment means, wherein said manual means includes part at least of the coupling means described in this specification.

One at least KGM preferably includes a power means for the apparatus of the invention. Said apparatus, as a non-limiting example preferably may include one at least:—LKM(s) and/or KGM(s) and/or KCM(s). Said power means is preferably a battery means as a non-limiting example. Said battery means preferably may be one at least of a) non-rechargeable means (eg dry cells, lithium, silver); b) rechargeable means (eg lithium; NiCad; Nickel Metal Hydride, Zn/Air). The KGM preferably may include electrical and/or electronic means as non-limiting examples. The KGM is preferably coupled to a means to recharge batteries (where appropriate). The KGM is preferably coupled to a battery low detection/indicator means.

The invention preferably allows for use of known art electronic keys with the means of the present invention. The invention preferably allows for the implementation of part at least of the means of known art electronic keys by the means of the present invention, non-limiting examples of which preferably may include power supply means and/or microprocessing means and/or I/O means.

The invention preferably allows that known art Key Ring Accessory Means may attach to the means of the present invention. The invention preferably allows for the implementation of part at least of the means of known art Key Ring Accessory Means by the means of the present invention (non-limiting examples of which preferably may include power supply means and/or microprocessing means, and/or I/O means).

The invention preferably allows for the use of the means of the present invention (non-limiting examples of which preferably may include power supply means and/or microprocessing means and/or I/O means) to facilitate functions of novel Key Ring Accessory Means (KRAM). Non-limiting examples of said novel KRAM preferably may include one at least of:—a) charms and/or astrological signs that include illuminated and/or audio means; b) GPS means c) fire lighting means (see below); d) torch means (eg high intensity LED means); e) secure electronic commerce means; f) secure password means; g) secure user ID information (eg name, address, telephone, Email); h) garage opener controller, i) vehicle lock controller, j) vehicle ignition controller, k) memory storage expansion means; l) remote undressing means m) medication dispenser n) means to interface with Lock ID Means o) means to interface with detached keys/LKM's (this preferably may be implemented by using unmodified KGM Plug Means and attaching this to said detached key to read and/or write information to said key, and/or modify said KGM Plug Means such that said plug is not affected by restraining means coupled to said key, thus facilitating temporary coupling of key and KGM); p) electronic device battery recharge means (see below); q) secure medical records; r) secure electronic prescriptions. It preferable that one at least KRAM's may be added to one at least KGM and/or removed under user control. The invention preferably allows that software may need to be loaded into memory storage means coupled to the invention to facilitate operation of one at least KRAM's. Said software preferably may be encrypted in part at least. Said software preferably may be encrypted for a particular KCM and/or KGM.

Key Ring Accessory Means preferably may be connected to and/or interface with one at least KGM by the means described for coupling LKM's to said KGM.

It is preferable that part at least of one at least personal electronic accessories may attach to the means of the invention, in particular to one at least KGM. Non-limiting examples of said electronic accessories preferably include part at least of one at least cellular telephones; and/or digital camera; and/or MP3 players; and/or PDA. In one embodiment said attachment is preferably mechanical in nature, for example to collate said electronic accessories with keys. In another embodiment said attachment preferably includes electrical connections between the means of the invention and said electronic accessories. As a non-limiting example said electrical connection may permit said electronic accessories to access the power means of the invention.

Activation and/or termination of Key Ring Accessory Means preferably may be in response to means described for controlling LKM's. Non-limiting examples of said activation/termination control means preferably include one at least of i) voice input; ii) keyboard entry, iii) menu selection from a display means.

Key Control Means (KCM. The control functions of the invention are preferably implemented by a Key Control Means (KCM) that preferably includes one at least of the following non-limiting means:—
1) Display Means (eg LCD). It is preferable that the display means may be upgraded by the user. The number of display embodiments is preferably not limited. The preferred embodiment preferably includes as non-limiting examples a) a basic monochrome LCD with one at least lines of alphanumeric sufficient to facilitate the basic key selection means of the invention; b) Monochrome LCD dot matrix display of one or more types used in cellular telephones; c) Colour LCD display of one or more types used in cellular telephones.
2) Keyboard Means (eg known art cellular telephone keyboard means).
3) Sound Output Means (eg known art cellular telephone speaker means).
4) Sound Input Means (eg known art cellular telephone microphone means).
5) Microprocessing Means (it is preferable that the CPU may be upgraded, preferably without soldering eg by unplugging the old device and plugging in a new device).
6) Memory Storage Means (preferably non-volatile in part at least, and preferably may be upgraded, preferably without soldering eg by unplugging the old device and plugging in a new device).
7) Control and/or Program and/or Operating System Software/Firmware.
8) Means to Automatically Read Lock ID Means. The preferred method is to include an RFID reader and/or writer. Other embodiments of Lock ID Means preferably may include direct electrical contact for the reader and/or wireless means. Methods of reading/writing these means are well known to the art, particularly given the optional means that preferably may be coupled to one at least KCM
9) Means to Read and/or Write to LKM's on detached keys.
10) Power Means. One at least KCM preferably may have its own power means, however, this is preferably a backup means. Non-limiting examples of said battery means preferably may include one at least of:—lithium battery means; rechargeable battery means; replaceable battery means; iv) capacitor means; solar cell means. The preferred primary source of power is from a power source coupled to one at least Key Grouping Means and transferred to said KCM via electrical conducting means. It is preferable that an auxiliary power means (eg battery) may be coupled (preferably reversibly) to the external enclosure of one at least KCM. One non-limiting application for said external battery may preferably be to enable the KCM to be detached from one at least KGM, to perform functions that preferably may be performed independently of and/or without a cabled connection to said KGM.
11) PDA Means.
12) Cellular Telephone Means. It is preferable that one at least KCM and/or KGM may include and/or be upgraded to provide a cellular telephone means. The preferred embodiment preferably includes the majority of the cellular components and aerials in the KGM (preferably moulded into part of the wall of the enclosure of said KGM and said part is preferably reversibly attached to said KGM) and preferably uses the means of one at least KCM to provide support functions (eg display, keyboard, microphone, speaker). Information is preferably transferred in part at least between said KCM and KGM via wireless means (eg bluetooth). This arrangement preferably packages the power thirsty components with the primary power means and also isolates high frequency and potentially noisy electronics from the KCM. It is preferable that said KCM may be detached from said KGM and preferably remain operational as a cellular handset.
13) Voice Recognition Means.
14) GPS means.
15) Secure Electronic Commerce Means.
16) Secure Password Means.
17) It is preferable that one at least KCM includes means to store information that may facilitate return of lost keys:—

Non-limiting examples of said stored information may include, as non-limiting examples:—a) name, and/or b) address, and/or c) telephone number, and/or Email address. Said information is preferably protected by encryption. It is preferable that reversal of said protection means is restricted. It is preferable that one at least authorised service providers may be able to reverse said protection. It is preferable that lost keys and/or encrypted information pertaining to said keys are provided to one at least authorised service providers to facilitate return of lost keys. It is preferable that said stored information may be transferred to a PC means and/or transferred to a service provider via the Internet.
18) Garage Door Controller (preferably secure).
19) vehicle lock controller (preferably secure).
20) vehicle ignition controller (preferably secure).
21) memory storage expansion means.
22) remote undressing means
23) medication dispenser controller/reminder;
24) secure medical records;
25) secure electronic prescriptions;
26) MP3 player,
27) RF Wireless Communication Means;
28) IrdA Interface;
29) Means to transfer information between one at least other KCM (eg IrdA, RF Wireless Communication);
30) Means to transfer information between said KCM and one at least user controlled data processing means (eg IrdA, RF Wireless Communication;
31) Means to attach/detach KCM to KGM Storage Means. A non-limiting example of said KGM Storage means is preferably a wall mounted unit that includes facilities to reversibly attach one at least KGM (eg by two preferably conductive openings in the end of the keytag) and/or one at least keys coupled to an LKM. It is preferable that said attached KGM and/or keys may be selected using as a non-limiting example, means similar to those described for selecting keys on a key grouping means. It is preferable that attachment and/or detachment of KGM's and/or Keys to/from said KGM Storage Means may include automated means (eg as described for keys attached to KGM's). It is preferable that one wire means may be used for interfacing between one at least KGM Storage Means and one at least KGM's and/or LKM's. It is preferable that RF Wireless communication may be used to communicate between one at least KGM Storage Means and one at least KGM.
32) means to recharge batteries from a power source coupled to one at least KGM storage means. 33) Dallas Semiconductors Java Cryptobutton;
34) Digital Camera Means. It is preferable that a digital camera component means that preferably includes optics, image capture means and image processing means and memory storage means may be coupled to said KGM. Said digital camera component means is preferably normally reversibly attached to one at least KGM pending attachment to a KCM. The KCM power supply is preferably augmented by said auxiliary battery. Said auxiliary battery is preferably normally reversibly coupled to one at least KGM pending attachment to said KCM. Said KCM is preferably detached from its coupled KGM. The digital camera component means preferably utilises KCM functions that are preferably essential for a complete Digital Camera System and preferably not included, in part at least, in said Digital Camera Component Means. Said KCM functions preferably may include as non-limiting examples, one at least of:—display means, microphone means, speaker means; I/O means, memory storage means, additional processing means, wireless transfer of data to another means (as a non-limiting example, a KCM bluetooth means preferably may transfer data to a bluetooth means in one at least KGM for storage in memory storage means coupled to said KGM and/or for transfer to a remote means via cellular telephone means preferably coupled to said KGM).
35) cordless telephone; 36) means to detect flashing PC keyboard LED as a means of receiving data; 37) RFID reader and/or writer; 38) electronic business card means; mm) means of encoding data as sound for transfer from KCM speaker means to PC microphone;
39) TV/VCR remote control means.
40) It is preferable that one at least KCM includes means to store information that may facilitate duplication of keys:—

Non-limiting examples of said stored information preferably include digitally stored information that may assist a key cutting machine to replicate one at least keys. Said stored information preferably may be obtained from one at least known art electronic means of determining key shape information. Said information is preferably protected by encryption and/or one at least passwords. It is preferable that reversal of said protection means is restricted. It is preferable that one at least authorised service providers may be able to reverse said protection. It is preferable that said stored information may be provided in part at least by the key supplier and/or key cutting service. It is preferable that said provided may include the transfer of information to said KCM by electronic means. It is preferable said stored information may be backed up in one at least user controlled data processing means (eg personal computer). It is preferable said stored information may be sent via the Internet.
41) The KCM preferably includes a unique ID Means that preferably may be read by external means and/or used by internal processing. The KCM preferably includes secure encryption/decryption keys and/or cryptoengines and part at least of secure systems are preferably distinct to a particular KCM. The KCM preferably may be uniquely address by other means by wired and/or wireless means. Said uniquely addressed preferably may be used to illuminate one at least KCM to facilitate selection of said KCM.
42) Digital Dictaphone.
43) Video Player.
44) Visual Timing Means—it is preferably that a LED (eg on front panel of KCM) and/or display means as non-limiting examples, may be flashed at one at least rates to provide a time base. As a non-limiting example one may want to allocate keyboard functions depending on the time that the key is depressed. A regular pulse (eg each half second) preferably may facilitate this.

The preferred embodiment of the invention preferably may include part at least of the means of a KCM in a key tag means. Said keytag means is preferably coupled to one at least Key Grouping Means. Said coupling is preferably by flexible and/or resilient cable means. Said cable means preferably includes electrical conductors (preferably insulated in part at least). Said key tag means is preferably able to move around part at least of said KGM. When one at least keys on a KGM is manually grasped, it is preferably that said keytag means may slide away from said selected key. This is a function of known art key rings. The invention preferably allows that the location of one at least parts of one at least KCM is not limited. It is preferable that part at least of the KCM functions may be coupled to one at least KGM as a non-limiting example.

It is preferable that one at least KCM may not be manufactured and/or sold with all available functions installed. It is preferable that known functions and/or newly developed functions may be added to said KCM at a later date. It will be appreciated by those experienced in the art that a preferably high performance CPU, suitable memory storage means, a secure processing engine (eg Java button), flexible I/O means and the option of a diversity of wired and wireless communication means, may provide substantial opportunities to provide a diversity of functions, and it is anticipated that the means of the present invention may provide and/or be adapted to meet many of the portable data processing requirements of consumers. The invention preferably allows for the interfacing via IR means and RF wireless communication to other electronic means, non-limiting examples preferably including one at least of wristwatch functions (eg display and/or keyboard) and/or spectacles (eg speaker attached to one at least spectacle ear stems and/or display means integrated into the lens means and/or projected from the spectacle frame).

It is preferable that additional hardware functions for one at least KCM are drop in or plug-in modules. It is preferable that software functions may be supplied in encrypted format and preferably only able to be used on a restricted number of KCM's (preferably one).

The known art describes a plurality of inventions applied to Key Tag Means. The preferred ability to provide a Key Grouping Means with power and/or electronic means preferably may permit the means and/or functions of one at least of said key tag inventions to be incorporated in part at least into the means and/or functions of one at least:—KGM(s) and/or KCM(s) and/or Key Tag Means of the present invention.

The known art describes a plurality of inventions applied to electrical and/or electronic means that are and/or may be attached to a key ring means other than a key tag means. The preferred ability to provide a Key Grouping Means with power and/or electronic means preferably may permit the means and/or functions of one at least of said inventions to be:—a) incorporated in part at least into the means and/or functions of one at least i) KGM(s) and/or ii) KCM(s) and/or iii) Key Tag Means of the present invention; and/or b) attached to one at least KGM.

The invention preferably may incorporate part at least of the means described in prior art PCT applications by John Griffits in addition to means described in US patents issued to Intertrust as an asignee. These are incorporated by reference.

The invention preferably allows for the method step of manufacturing LKM's wherein digitally stored information that may be coupled to one at least LKM's, is stored in electronic means. Said digitally stored information preferably represents one at least bit sequences that may be used to represent one at least ID Codes. Said digitally stored information preferably may have been incorporated into one at least LKM and/or may be available for incorporation in one at least LKM.

The invention preferably allows for the method step of transferring and/or copying part at least of the information stored within a first KCM to one at least second storage and/or processing means. Said second means preferably includes one at least second KCM and/or one at least user controlled data processing means (eg PC). Said transfer and/or copying preferably may include the use of one at least WAN's (eg the Internet). The invention preferably includes the method step of manufacturing one at least Key Grouping Means (KGM) and/or Key Control Means (KCM) and/or Local Key Means (LKM) and/or other means described by the invention.

The invention preferably includes the method step of manufacturing and/or distributing, and/or selling, and/or fitting a power source means for one at least Key Grouping Means (KGM) and/or Key Control Means (KCM) and/or Local Key Means (LKM) and/or other means described by the invention.

It is a non-limiting preferable objective of the present invention to include the method and/or process of advertising and/or promoting one at least Key Grouping Means (KGM) and/or Key Control Means (KCM) and/or Local Key Means (LKM) and/or other means described by the invention.
Said advertising preferably may include one at least of television, cinema, radio, printed matter as non-limiting examples.

It is a preferred objective of the present invention to include the process and/or method, of ordering, and/or selling (that may include sale, and/or hire, and/or rental and/or leasing, as non-limiting examples) and/or exporting, and/or importing, and/or transporting:—
from a first jurisdiction to one at least second jurisdiction, and/or from a first location to one at least second locations, of one at least Key Grouping Means (KGM) and/or Key Control Means KCM) and/or Local Key Means (LKM) and/or other means described by the invention.

A non-limiting example of a Key Ring Accessory fire-lighting means preferably includes resistive wire that heats up sufficiently when current is passed through that it may ignite flammable material. Said current is preferably controlled in part at least using the means described to activate/disable illumination means coupled to one at least LKM's. Said heat source is preferably protected against accidental use by mechanical and electronic means. Said mechanical means preferably may include a spring that normally keeps said heating element apart from electrical contacts until pressure applied by user. It is preferable that one at least keyboard switches must be kept depressed during the heating cycle.

Recharge Key Means. The present invention preferably allows for one at least recharge keys preferably vehicle and/or boat and/or plane ignition keys) to be coupled to one at least KGM such that when said key is in said ignition (and/or other lock means) that power may be applied via said key to the means of the invention and/or means electrically coupled to the means of the invention (eg said personal electronic accessories). As a non-limiting example, the LKM coupled to one at least vehicle ignition keys is preferably equipped with two socket means—the first coupled to ground and the second preferably connected to a voltage converter means (eg transformer) to convert a vehicle battery voltage to one useable by the means of the invention. The output of said transformer means preferably may be output onto the positive rail of one at least KGM. Said positive rail is preferably protected by overvoltage from said transformer output. Said output is preferably switched by Key Control Means. Said output voltage is preferably higher than normal operational voltages and still within the normal operating voltage range of directly connected devices. The presence of said higher voltage preferably acts as a power source to recharge batteries connected to the means of the present invention (eg those within said KGM and/or those in attached personal electronic accessories) and an indicator means that recharge power is available. It is preferable that when said recharge key is inserted in the vehicle ignition that said first socket means makes electrical contact with a first plug means connected to the vehicle ground and said second socket means makes contact with a second plug means connected to the vehicles positive voltage (usually approximately 6 or 12 volts). It is preferably that said first and/or second plugs only make contact with the vehicles power source when the ignition key is turned to the on position or the accessory position. Said vehicle electrical source is preferably coupled to conductor platform means surrounding the ignition lock key access, preferably with conductors in one at least positions to make appropriate contact with said first and second plug means. Said vehicle conductor platform means preferably has a central opening to permit entry/exit of the ignition key. Said conductor platform means preferably may have an adhesive backing to facilitate coupling with the ignition lock surrounds. Said conductor platform means preferably has a means to couple to the vehicle ground and power system. Said first and second plug means are preferably on a support means that may rotate on said conductor platform means. Said support means preferably has a central opening to permit passage of the ignition key. The vehicle component of the recharge key means preferably may be fitted to existing vehicles and/or fitted to new vehicles. Said support means is preferably locked in position when the key is removed from the ignition and enabled for rotation when the key is inserted. Said locked position preferably lines up said plug means with said socket means when said recharge key is inserted into the ignition. The recharge key means preferably permits means coupled to the invention to operate and/or recharge batteries from the vehicle power source. A means of coupling the power means of personal electronic accessories to the power means of the present invention has been described. Clearly the recharge key means preferably may be used to recharge batteries and/or power part at least of one at least personal electronic accessories.

### PREFERRED EMBODIMENT OF THE INVENTION

The preferred embodiment of the invention is now described as a non-limiting example with reference to the drawings. It should be noted that the drawings are not necessarily to scale and/or proportion. They are to assist the reader to understand a preferred means of constructing the apparatus of the invention.

It should be noted that it is a preferred objective of the invention to allow for RF shielding using prior art means in the production of one at least parts of said invention. Non-limiting examples preferably may include metal shielding, conductive plastics, conductive flexible seals, conductive metal film applied to one at least surfaces. Shielding means may not be shown in the drawings and/or specifically described as they are means known to those experienced in the art.

The reader is referred to Figure One of the drawings. The present invention preferably seeks to describe a means to facilitate the coupling of one at least keys with one at least locks. Non-limiting examples of said coupling may be to action said lock(s). The drawing shows keys 3a, 3b, 3c, 3d, 3e, and 3f, however, the number of keys that the invention may be applied to is preferably not limited. The drawing shows lock means 4a, 4b, 4c, 4d, 4e and 4f, however, the number of locks is preferably not limited. The locks in Figure One are shown coupled to filing cabinets, a safe and doors. It is preferable that the means that locks are coupled to are not limited.

Whether as a single key and/or a plurality of keys collated by a Key Grouping Means, one problem that may be encountered in the use of keys is determining:—a) the lock(s) that one at least key is to action; and/or b) the key(s) that may action one at least locks.

As a non-limiting example, the function of one at least keys may be forgotten—a problem that may become more pronounced for infrequently used keys. As another non-limiting example, one at least keys (eg. 3a-3f) preferably are collated by one at least Key Grouping Means, that in the example of Figure One is represented by Key Ring Means (2). Selecting the appropriate key for a particular lock(s) may be problematic—a task that may be more difficult if keys have a similar appearance, and/or environmental conditions make it difficult to see, and/or there are a large number of keys to select from. As a non-limiting example, office filing cabinets frequently have keys that are difficult to distinguish, a situation that may result in reduced security as employees may prefer to leave the locks undone rather than endure the hassle of finding the correct key.

One preferred non-limiting objective of the present invention is to describe one at least Lock ID Means (5) to identify one at least locks, preferably using electronic reading and/or writing means. The drawing shows Lock ID Means 5a, 5b, 5c, 5d, 5e, and 5, however, the number of Lock ID Means is preferably not limited. The number of locks that may be coupled to one at least Lock ID Means is preferably not limited.

One non-limiting application of said Lock ID Means preferably includes facilitating the selection, preferably using automated and/or electronic means, of one at least keys that may action said lock. It is preferable that said automated and/or electronic selection of one at least keys may not require the use of said Lock ID Means. It is preferable that one at least locks may not be coupled to one at least Lock ID Means. One at least Lock ID Means preferably includes one at least bit codes that may be read and/or written electronically, and said code is preferably unique. The number of bits in said code is preferably not limited by the invention.

It is preferable that one at least Local Key Means (LKM) (as a non-limiting example, 6a . . . 6f) may be coupled to one at least keys (as a non-limiting example, 3a . . . 3f). It is preferable that said LKM may be coupled to one at least LKM ID Means (not shown in this drawing), a non-limiting example of which preferably includes:—a) one at least bit sequences stored in electronic format (preferably in a non-volatile memory storage means); and/or b) one at least machine readable codes (non-limiting examples of which preferably include:—bar codes and/or other indicia printed on the one at least keys and/or means attached to one at least keys). A non-limiting example of said machine readable may include the use of imaging means (eg CMOS image sensors and/or Barcode reader). It is preferable that said LKM ID means is unique to one at least LKM. It is preferable one at least said LKM ID means may be used as an electronic address for external means to interface with said LKM. It is preferable one at least said LKM ID means may be read and/or written electronically by means internal and/or external to said LKM.

It is preferable that one at least said LKM may be coupled to one at least LKM Key Description Means (LKDM) (not shown in this drawing) that preferably describes the lock(s) that the key(s) coupled to said LKM may action. Non-limiting examples of said LKDM preferably may include:—
a) One at least bit sequences stored in electronic format (preferably in a non-volatile memory storage means). A non-limiting example of said bit sequence(s) preferably may include one at least of:—i) Text LKDM (eg. an ASCII String); ii) Audio LKDM (eg. Digitised sound waveforms); iii) Image LKDM (eg digitised image of target means); iv) GPS LKDM (eg GPS co-ordinates of target means); v) Lock ID LKDM (eg. binary string(s) of one at least Lock ID Means coupled to one at least locks, wherein one at least said lock(s) may be actioned by the key(s) coupled to said LKM). and/or
b) One at least human readable indicia and/or backgrounds, that as non-limiting examples preferably include one at least:—colour(s); and/or alphanumeric(s) and/or geometric shape(s); and/or pattern(s).

It is preferable said LKM Key Description Means may be read and/or written electronically by means internal and/or external to said LKM

It is preferable that one at least said LKM is coupled to an Indicator Means (not shown in this drawing).
It is preferable said LKM is coupled to an Indicator Control Means to activate and/or inactivate said indicator means.
   It is preferable said indicator control means may be addressed and/or influenced by means external to said LKM.
It is preferable said indicator means includes an illumination means. It is preferable said illumination means includes one at least LEDS, and/or LEP's and/or OLEDS as non-limiting examples.
It is preferable said indicator means may be activated. A non-limiting example of said activated preferably may include the switching of an illumination means from OFF to Illuminated state (eg. turning a LED ON).
   It is preferable that said activated indicator means may be used to facilitate selection of one at least keys from a plurality of keys, wherein said key(s) may be used to action one at least locks.
      As a non-limiting example, it is preferable that if intending to action lock (4c), that a means signals the LKM (6c) coupled to the action means key (3c), to activate said LKM (6c) indicator means (eg illuminates its LED), to facilitate selection of the key (3c) from a plurality of keys (eg. 3a . . . 3f).
   It is preferable that said activated indicator means may be used to facilitate identification and/or the function of one at least keys.

It is preferable that said LKM is coupled to a means to receive information pertaining to one at least locks that requires action (locking and/or unlocking) and/or a means to determine the ID Means of one at least LKM(s) that may facilitate said action.

As a non-limiting example, the keys shown coupled to key grouping means (2) in Figure One preferably may have the following, non-limiting properties:—Keys (3a) and (3f) may each be used to action lock (4f). In other words, key grouping means (2) includes two keys that may be used to action lock (4f). In the present example either key may action lock (4f) on its own. The invention preferably allows for other embodiments wherein a plurality of keys may be required to action one at least locks. Key (3b) may action lock (4a) and lock (4b). Key (3c) actions lock (4c). Key (3d) actions lock (4d). Key (3e) actions lock (4e).

The invention preferably includes a Key Control Means (1) that preferably may also function as a Key Tag Means and/or Key Grouping Means as non-limiting examples. Key Control Means (1) preferably may be coupled by wireless and/or wired means to one at least:—LKM and/or keys; and/or Lock ID Means and/or KGM, as non-limiting examples. The Key Control Means (KCM) (1) preferably may include part at least of the means described for KCM and/or LKM's in this specification. The KCM (1) preferably may include one at least other known art functions for key ring tags.

The Lock ID Means (5) is now described in further detail with reference to Figure Two of the drawings.

A preferred non-limiting example of a non-electronic embodiment of a Lock ID Means (5) may be a label with human readable indicia as shown in block drawing (10) of Figure Two, that shows a Lock ID Means (5g) that includes indicia (11) of one at least colours (eg black) printed on a background (12) of one at least colours (eg white). Block drawing (10a) is a cross section A-B through the Lock ID Means (5g). Said label is preferably manufactured of a resilient and/or flexible material (13), a non-limiting example of which is preferably plastic. Said label is preferably manufactured from waterproof materials. Said label preferably includes an adhesive means (14) on at least one surface (eg the back). Said adhesive is preferably protected against unintentional sticking by an adhesive protection means (15) (eg, by a backing paper). Non-limiting examples of said adhesive means preferably may include one at least of the adhesives in the 3M Corporation catalogue. It is preferable that a machine readable means (eg bar code (16) may be added to and or replace indicia means (11). Preferably known art means may also be used to read the indicia means (11), eg CMOS Imaging means (not shown).

Another preferred non-limiting example of a non-electronic embodiment of a Lock ID Means (5) may be a label with human readable indicia as shown in block drawing (20) of Figure Two, that shows a Lock ID Means (5h) that includes one at least shapes (21) of one at least colours, on one at least backgrounds (22) of one at least colours. For example a first Lock ID Means may include red triangles on a blue background, and a second Lock ID Means may include green circles on an orange background. It is preferable that one at least means described in the previous example with reference to block drawing (10) may be included with part at least of the means described with reference to block drawing (20).

It is preferable that one at least indicia means may illuminate. A non-limiting example of said illuminate preferably may include the use of ‘glow in the dark’ materials.

A preferred non-limiting example of an electronic embodiment of a Lock ID Means (5j) is described with reference to block drawing 25 of Figure Two of the drawings. It is preferable that said electronic embodiment continues with the theme described in the preceding two non-limiting examples of non-electronic embodiments by using a label based approach, preferably constructed in part at least of plastic. It is preferable that the electronic means are embedded in part at least within the matrix of said plastic. It is preferable that said electronic means does not require its own power source. Furthermore it is preferable that said electronic means may be powered and/or read and/or written by contactless means.

A non-limiting example of a preferred electronic means for one at least Lock ID Means preferably includes RFID Means (26).

A non-limiting example of a suitable RFID device preferably may be the EM4102 RF Transponder from EM Microelectronics. The data sheet for this device is incorporated by reference. This chip is a read only contactless identification device that is preferably embedded in the matrix (eg plastic) (13) of the label means of the Lock ID Means (5j). Said RFID Means is preferably connected to a coil means (27). Said coil means is preferably embedded within said matrix (13) and/or manufactured onto the surface of said label means. Non-limiting examples of said coil means preferably may include printed circuit copper traces and/or printed conductive inks. This arrangement does not require a power means (eg battery) to be connected to the RFID Means (26). Power is induced in the coil when the device is read by an external means. It is preferable that the Lock ID Means (5j) includes a unique serial number that may be read by external means. It is preferable that said serial number is factory programmed. The EM4102 provides a 64 bit serial number—the large number of combinations that this allows for, effectively provides a unique number for each device. Any duplications are unlikely to have any practical effect. The serial number is laser programmed into the EM4102 during manufacture.

A second non-limiting example of a suitable RFID device preferably may be the EM4450 or EM4550 RF transponder from EM Microelectronics. The data sheet for this device is incorporated by reference. This device has similar properties to the device of the preceding example, however it also has 1K bits of non-volatile memory that may be written as well as read. Like the preceding device, the 64 bit serial number is laser programmed at the factory. This is a non-limiting example of a contactless Read/Write Lock ID Means.

It is preferable that the electronic means used to implement a Lock ID Means is not limited by the invention. Other non-limiting examples preferably may include one at least of:—

The use of Dallas Semiconductors ‘onewwire’ DS2401 ‘Silicon Serial Number’. The data sheet for this device is incorporated by reference. This embodiment of a Lock ID Means (5k) is described with reference to block drawing (30) of Figure Two of the drawings. The DS24021 is represented by chip (31) that is preferably embedded within the matrix of the label means. Power and logic is delivered over multiplexed electrical conductor (33) with the power return via means (32). The electrical contacts are preferably arranged and/or polarised to prevent reversal and/or shorting—these methods are known to the art. The embodiment of block drawing (30) preferably may be considered a non-limiting example of a Read Only Contact Lock ID Means that is powered from a remote source.

The use of the Motorola 68HC908QT1 Microcontroller preferably may also be programmed to perform as another non-limiting example of a contact Lock ID Means (5m) that is powered by a remote source. The data sheet for this device is incorporated by reference. This configuration is not shown in the drawings, however, it would usually require a minimum of three electrical contacts—Power, Ground and at least one signal line. It is preferable that a power means (eg, a battery and/or solar cell) may be coupled to Lock ID Means (5m) to preferably remove the requirement for an external power means. This may for example, reduce the number of electrical contacts to two. The 68HC908QT1 includes 1.5 Kbytes of application programmable memory. It is preferable that the Lock ID number is programmed at the factory, however, it is also preferable that part at least of said flash may be used to store other parameters, that preferably may be written to the device after manufacture, and preferably under the control of the user of the invention. This is a preferred non-limiting example of a Contact Read/Write Lock ID Means. The invention preferably allows for the Lock ID Means to communicate by wireless means—non-limiting examples of which preferably may include IR and/or RF means. The use of said 68HC908QT1 and a coupled power means (eg battery and/or solar cell) and a suitable IrDA and/or RF chip set, is preferably a non-limiting example of a Contactless Read/Write Lock ID Means (5n) that uses IR and/or RF for communications.

It is preferable that part at least of the means described for one at least embodiments of a Lock ID Means may be combined with part at least of one at least other embodiments of a Lock ID Means.

A non-limiting example of a preferred usage of the read and/or write memory (48) coupled to one at least Lock ID Means is now described with reference to Figure Three of the drawings. Memory Storage Means (48) preferably may include, as non-limiting examples, one at least of:—Lock ID Code (52)—this is preferably present in each Lock ID Means. It is preferable that there is a Lock ID Code Length (50) to specify the number of bits in said Lock ID Code (52). It is preferable that embodiments that include a fixed Lock ID Code (eg, the 64 bit code of the EM4102, EM4550, and/or DS2401) do not require said Lock ID Code Length (50). It is preferable that the Lock ID Means may include a list of one at least Keys that may action the lock coupled to said Lock ID Means. The preferred means is to store the Key ID Code (eg 58, 68, 78, 88 and/or 98) of one at least LKM(s) coupled to said key(s). It is preferable that there is a means to record the Number of Key ID Codes (54) stored in said Lock ID Means. It is preferable that there is a means to record the length of one at least Key ID Codes (eg 56, 66, 76, 86, and/or 96). It is preferable that information pertaining to the external appearance of one at least related LKM's may be stored in one at least Lock ID Means. As a non-limiting example, said LKM may have characteristic indicia, shapes, colours, backgrounds that facilitate visual identification by a human user. It is preferable that said characteristics match those on the related Lock ID Means (eg as previously described with reference to (10) and (20) of Figure Two). It is preferable that there are one at least Flags (eg a single bit) coupled to one at least stored key ID codes (eg, 58, 68, 78, 88, and/or 98). Non-limiting examples of said flags preferably may include one at least of Key Descriptor Flags 60, 70, 80, 90 and/or 100). In the example embodiment a bit set to one equates to the presence of one at least key descriptors and a bit cleared to zero equates to no descriptor. It is preferable that there is a means to store the length of one at least key descriptors (eg 64). Non-limiting examples of said length means preferably may include one at least Key Descriptor Length Means (eg one at least of 62, 72, 82, 82, 92, 102). It is preferable that information pertaining to the GPS co-ordinates of the coupled lock and/or the Lock ID Means may be stored in (106) of memory map (48). It is preferable that information pertaining to a description of the means that the coupled lock is attached to may be stored in (108) of memory map (48). It is preferable that one at least of the following non-limiting examples may form part of the coupled description means:—a) text description eg. ‘orange and brown two drawer filing cabinet in surgery number one’; b) digitised sound waveform eg of text description above; c) digitised image of means that lock is coupled to. A non-limiting example of a sub-memory map (10) that provides a more detailed description of a non-limiting example of a key descriptor arrangement is now described. The number of components in the descriptor is preferably provided in Descriptor Component Count (112)—for example a descriptor that included a yellow triangle and green circle on a rectangular blue background may have a count of three—one for three triangle, one for the circle, and one for the background. Each object is preferably described in more detail, for example, the first object (eg the triangle) is described starting at Descr#1 (114), the second object (eg the circle) starting at Descr#2 (122) and the third object (rectangular background) is described starting at Descr#3 (130). Descr#n Plane (148) preferably describes if the object is foreground or background. Descr#n Type (150) preferably indicates if the object is a shape or alphanumeric. Indicia Code #n (152) preferably describes the actual indicia letter, value or shape as appropriate to (152). Colour Code #n (154) preferably describes the colour of the object.

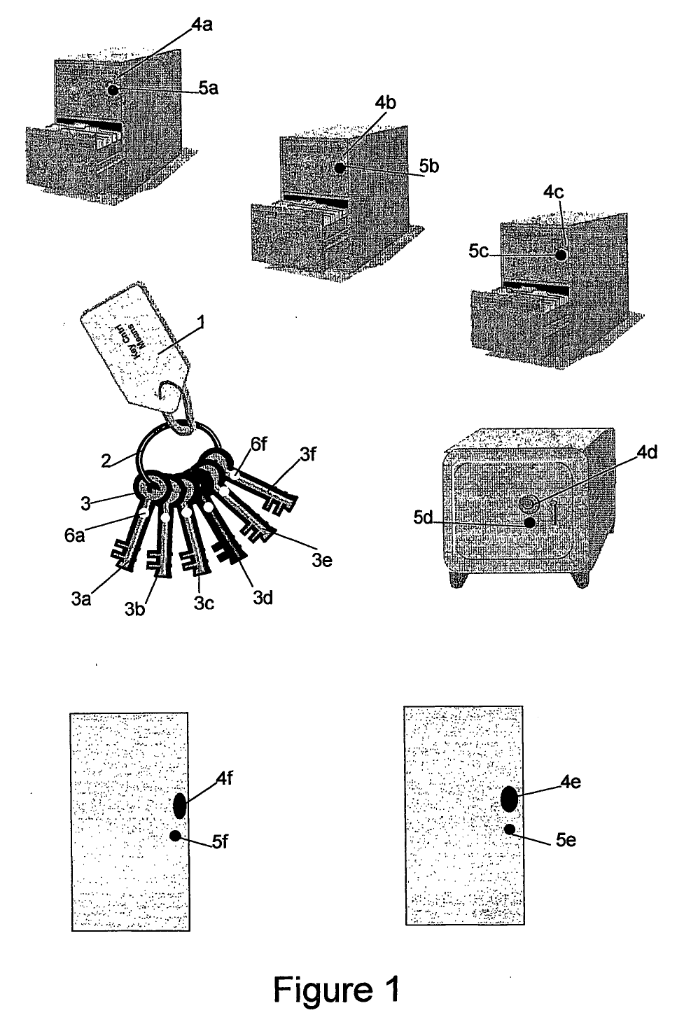

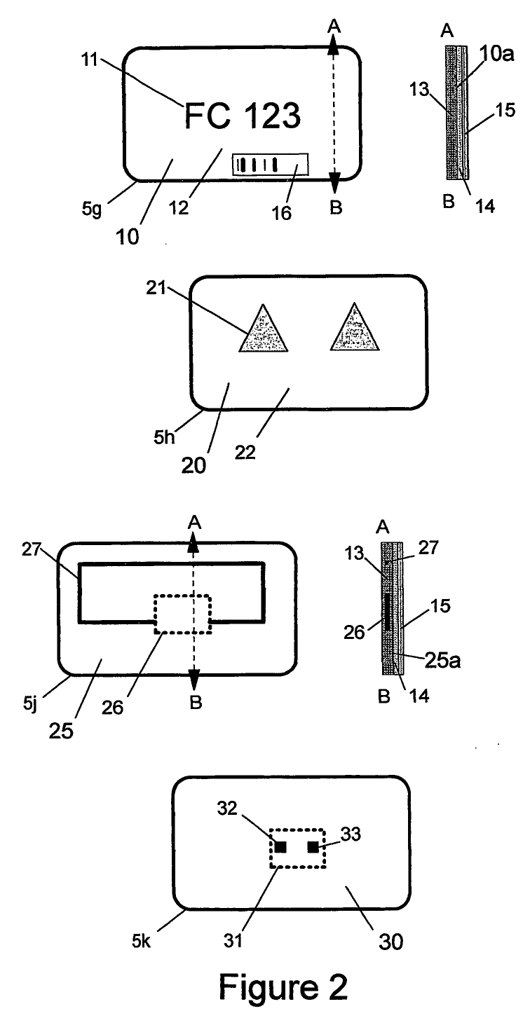

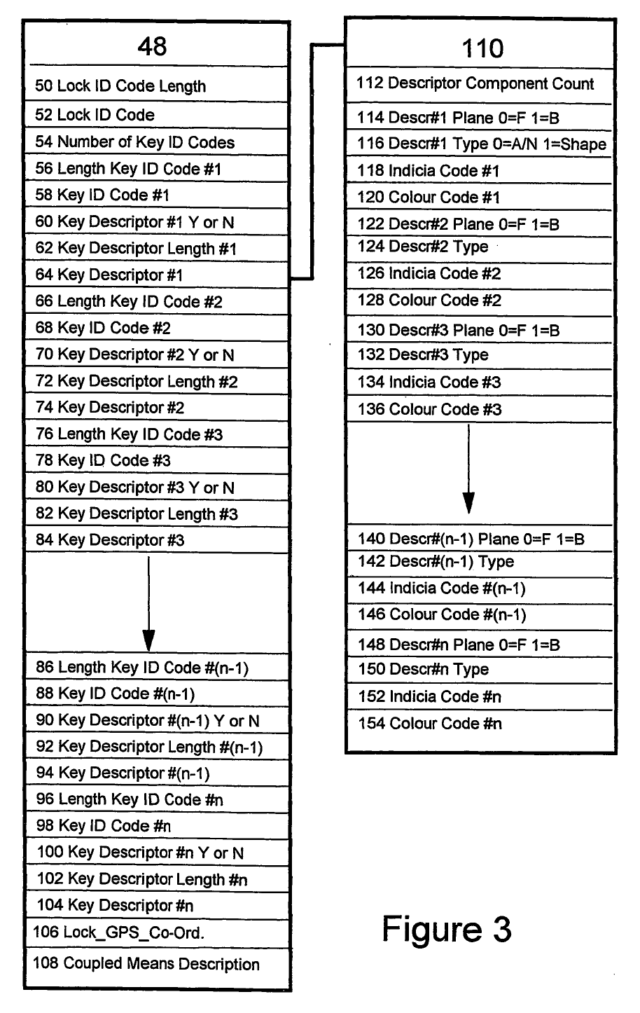

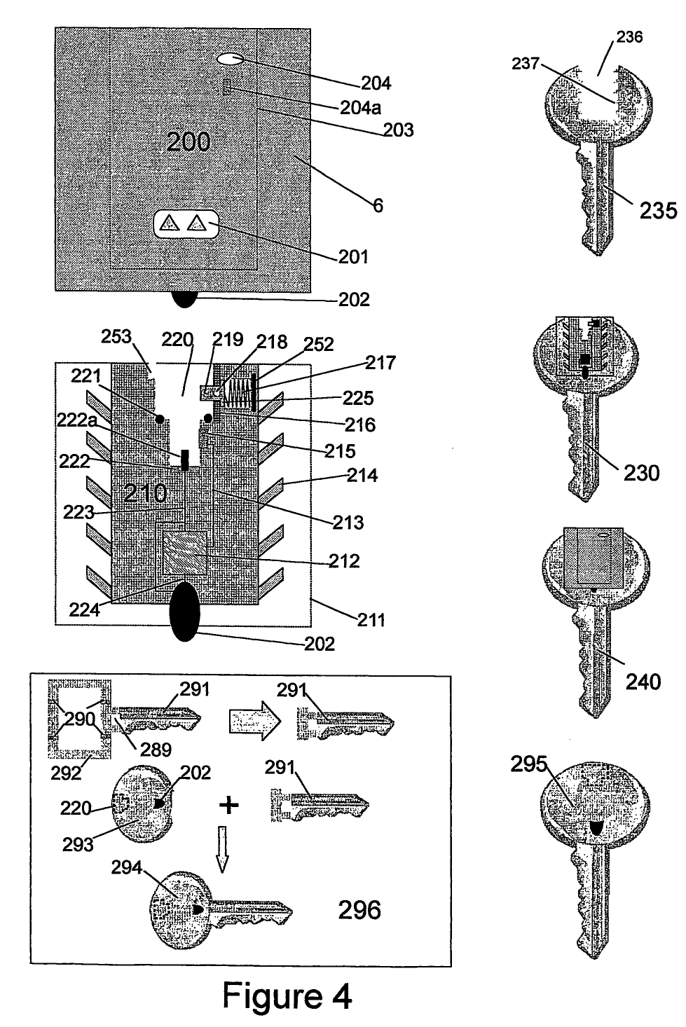

Non-limiting examples of preferred embodiments of Local Key Means (LKM) are now described. The preferred embodiments preferably may include automated and/or electronic means coupled to said LKM. One at least embodiments preferably includes automated and/or electronic LKM ID Means. One at least embodiments preferably includes non-automated and/or human readable LKM ID Means. One at least embodiments of an LKM preferably may include non-automated and/or human readable LKM ID Means and not include automated and/or electronic LKM ID Means. One at least embodiments of an LKM preferably may not include automated and/or electronic means. The examples described with reference to FIGS. 4, 5, 6, and 7 should allow those knowledgeable in the art to construct LKM's that meet one at least of the preferred embodiments of LKM's.

It is preferable that the invention allows for LKM's designed to be coupled to keys specially ma red to accommodate one at least LKM's that preferably may not fit prior art keys. Non-limiting examples of these LKM's and non-limiting examples of suitable keys are described with reference to FIGS. 4 & 5 of the drawings.

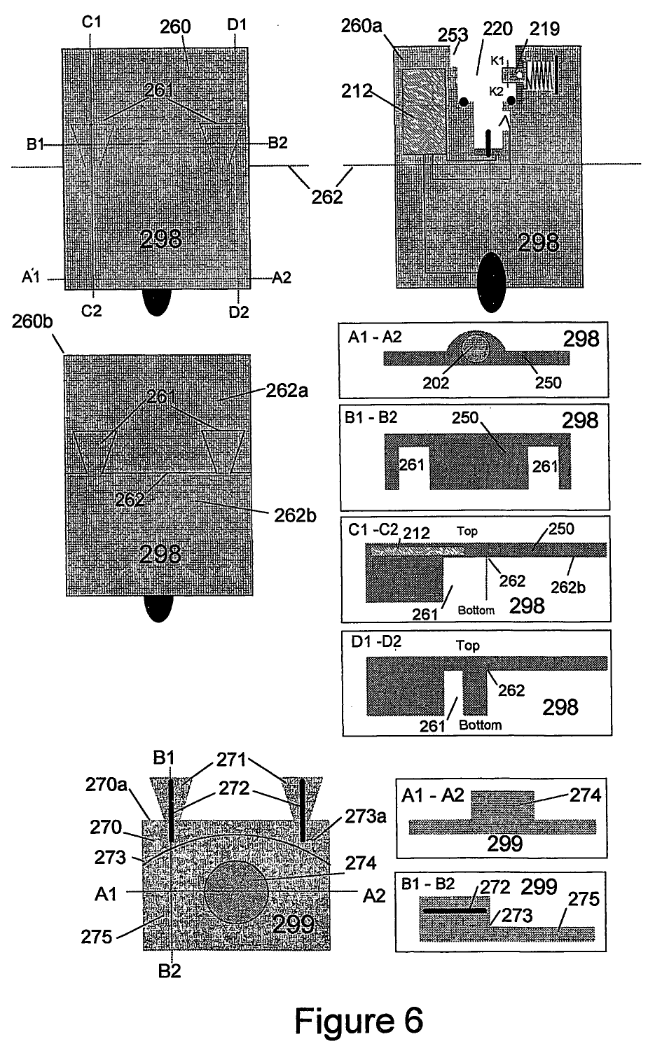

It is preferable that the invention allows for LKM's designed to be coupled to prior art keys. Non-limiting examples of these LKM's are described with reference to FIGS. 6 & 7 of the drawings.

The preferred arrangement for an LKM is to have each distinct key coupled to its own, preferably unique, LKM

The invention is now described with reference to Figure Four of the drawings.

It is preferable that said LKM (6) includes one at least indicator means (202) that as a non-limiting example, preferably may be used to advise the user that said LKM has been selected. The preferred non-limiting indicator means are audible and/or vibrating and/or illumination means. The example of FIG. 4 uses a LED as an illumination means that is switched by integrated circuit means (212). It is preferable that any illumination means, alone or in combination may be used, non-limiting examples of which preferably may include one at least of LED, Organic Light Emitting Diodes (OLED), Plasma Display Means, Light Emitting Plastics (LEP), Organic Light Emitting Plastic (OLEP's). The use of the term LED in this specification preferably may be interchanged with any other illumination means, non-limiting examples of which preferably include OLED's and/or LEP's, OLEP's, and/or LCD's. A non-limiting example of an audible means preferably may be a piezo-electric speaker means.

The preferred embodiment preferably includes a means to power the indicator means (eg. Illumination Means (202)) and a means to Enable and/or Disable activation of said Indicator Means. In the example of FIG. 4, IC (212) sinks current from the LED (202) via conductor (224). Power is delivered along conductor (223). It is preferable that when activated, said LED emits light and when inactivated, said LED ceases to emit light. In the present embodiment enabling/disabling the Indicator Means is preferably switched by IC (212) and said switching in part at least is preferably under the control of means remote to the LKM (eg the Key Control Means, not shown in this drawing).

While the drawing shows a single LED, it is preferable that the number of LED's is not limited. It is preferable that the colour of light and/or intensity of light emitted by said LED is not limited. Non-limiting examples of said colour preferably may include one at least of red, green, yellow, blue, orange, white. In the present example there is only a single LED that is illuminated when active. As non-limiting examples, the illumination means may preferably be used for one at least of the following:—
a) to indicate that the illuminated key is the key required to action a lock(s);
b) to assist illumination of the lock means into which said key may be inserted (it is preferable that the beam of light from the LED is directed in a manner to facilitate this);
c) that the illuminated key has been selected for other functions (eg editing of coupled LKM Key Description Means).

It is preferable that there is a means to facilitate orientation of one at least keys key prior to attempting to insert said key into the appropriate lock. The preferred method is to use the speaker means and/or display means of the KCM to indicate whether or not the top edge (for keys cut on one edge only) is up, or down, or right, or left. A preferred alternative may be to flash one at least LED's (eg on LKM's adjacent to the selected key) at different rates to code the orientation (for example one LKM LED flashing twice a second may indicate the top edge is uppermost, and four times a second may indicate top edge down; two LKM LED's flashing twice a second=top edge right, and four times a second=top edge left). It is preferable that there is one at least means to indicate to the user if a key should be turned clockwise or anticlockwise for a particular action (eg lock or unlock), with the preferred method being to have the speaker means issue a voice instruction. An alternative preferred method is to flash one at least LED's coupled to a KGM and/or KCM for clockwise and no illumination for anticlockwise. There is preferably a means for the user to advise the KCM of a requirement for this function and the type of action. This preferably may be keyboard entry and/or menu selection from a display and/or voice input command (eg the phrases ‘Lock Direction’ and ‘Unlock Direction’ are preferably commands recognised by means coupled to said KCM).

It is preferable that said LKM receives power via electrical conductors from an external means (eg the KGM and/or KCM)). Said external means preferably may power plural LKM's. A power conductor (223) is shown in block drawing (210) of Figure Four of the drawings. A return line (213) (eg Ground) is also shown. It is also preferable that data and control signals are tansferred to and from the LKM via electrical conductors. It is preferable that data and control lines are digital signals.

It is preferable that the number of electrical conductors required to interface the LKM with other means is kept to a minimum. The use of the Dallas Semiconductors ‘One Wire’ interface allows both power and all data/control signals to transfer on the power line. This method has a distinct advantage of only requiring two conductors—Vcc and Ground. In the present embodiment, Vcc/Data/Control enter the LKM at interface (222) and are conducted to the IC (212) via conductor (223). Ground returns via conductor (213) to interface (215). The DS2405 (212) is a non-limiting example of a onewire device that preferably may be used with the means of the present invention. The Dallas Semiconductor Data Sheet for the DS2405 is incorporated into this specification by way of reference.

It is preferable that plural LKM's may be connected to the same conductors. The DS2405 permits this.

The DS2405 has three connections. The first is the power line (223) that brings in Vcc and also conducts data and/or clock signals to/from the device. The second is the power return line (213). The third connection to the DS2405 is the output pin (224). This is an open collector output that is normally switched off when the device is reset. A pull-up resistor pulls the output towards Vcc. The output (224) may be switched to ground by an external means (eg CPU in KCM) reading and/or writing the necessary bit sequence(s) to the DS2405 along conductor (223). This usually includes sending a bit sequence that equates to the unique ID within said DS2405, together with the required command sequence (refer to DS2405 data sheet). When switched to ground, the output (224) sinks sufficient current to keep the output low despite the pull-up resistor.

Output (224) may be used directly to sink current supplied directly to the indicator means, illuminating the LED in the process, however, the limited sink capability (4 ma) may restrict this and an improved output means (eg transistor and/or buffer means) may be need to be added.

It is a preferred and non-limiting objective to provide each LKM with a preferably unique LKM ID Means. Said ID Means is preferably in an electronic format and preferably may be read by external means (eg KCM as a non-limiting example). Said external means preferably includes an electronic means. Said ID means preferably may be used to individually address electronic means within said LKM The DS2405 is a non-limiting example of a device that includes an ID means that meets the requirements of the present embodiment of the invention.
Said DS2405 ID means includes an 8 bit function identifier (eg one possible 8-bit combination may specify the device as associated with the means of the present invention). It also includes a 48 bit address that is preferably unique to a particular device. It also includes an 8 bit CRC means to assist in error correction and/or detection. The appropriate bit combinations are usually laser programmed into the chip prior to encasing it in its plastic package.

The invention preferably allows for any means of programming ID bits—eg Flash Memory and/or EEPROM as non-limiting examples. The invention preferably allows for any number of bits to be used in said ID means. The invention preferably does not require a function identifier means. The invention preferably does not require a CRC means.

The DS2405 does not include user programmable memory and part at least of the LKM Key Description Means are preferably stored external to the LKM—eg in the coupled KGM and/or KCM. The invention preferably allows for the use of a device that includes programmable memory. One non-limiting option is preferably to have the DS2405 modified by the manufacturer to include both an improved output driver for the LED and flash memory. An alternative is the use of the Dallas Semiconductor DS2406. This onewire device includes two addressable outputs with improved current sinking compared with the DS2405. It also includes 1K bits of OTP EPROM. The data sheet for this device is incorporated by reference.

The LKM is preferably not limited to one wire means as described by Dallas Semiconductors and is preferably not limited to the number of conductors used for power and/or ground and/or data and/or control. The LKM is preferably not limited to means that share power and data on the one conductor.

A preferred alternative option for IC (212) is the use of a Microcontroller. This may require additional conductors (not shown in the drawings). One example may be the use of the Motorola 68HC908QT1 previously described with reference to Lock ID Means. This device has 1.5 K bytes of flash memory that in addition to the application program, preferably is programmed with the LKM ID Code and/or part at least of the LKM Key Description Means.

The preferred means of delivering Vcc and Ground to/from the LKM (6) of block drawing (210) of FIG. 4 is by a KGM Plug Means (not shown in this drawing) that links to LKM Socket Means (220). It is preferable that Vcc on the plug interfaces with the Vcc pin (222) of the LKM and that the ground line of the plug interfaces with ground connector (215).

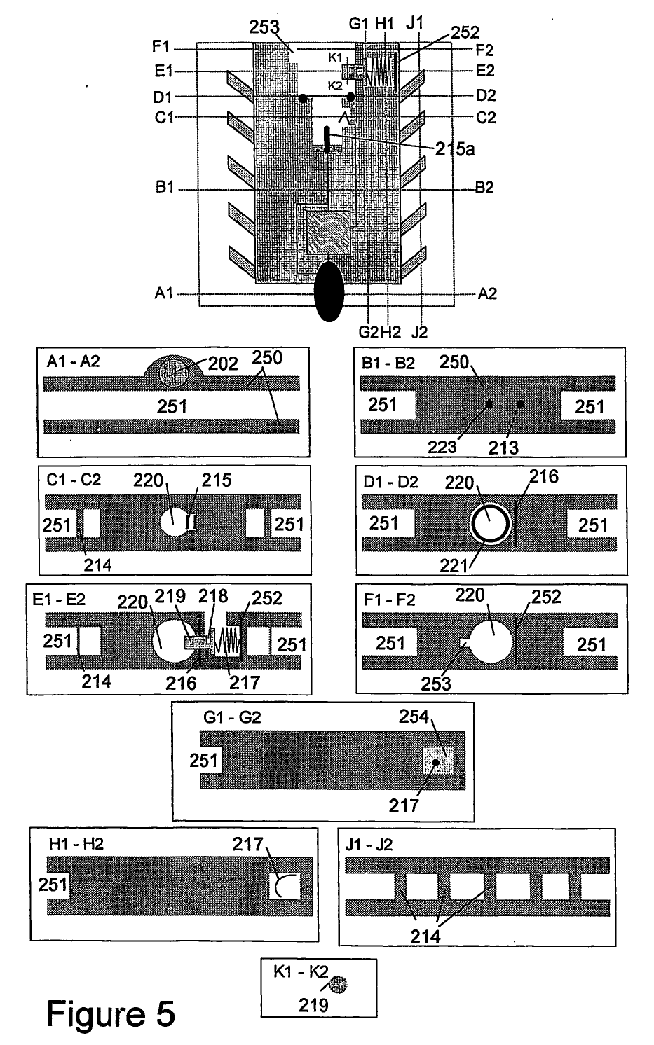

Non-limiting examples of ground connector means preferably may include conductive rubber (or similar material) (215) as shown in block drawing 210 and/or resilient and flexible metal contact as depicted in (215a) of FIG. 5. The preferred connection means for Vcc is a pin (222a) that mates with a suitable receptacle on the plug means that couples to socket means (210).

The LKM preferably includes a means to protect against entry of water and/or other materials into the part of the LKM that houses the electrodes. One non-limiting example is preferably to include a rubber (or similarly suitable material) ‘O’ Ring (221). Insertion of the plug means preferably completes the seal.

The LKM preferably includes a plug retaining means to retain the KGM Plug Means in LKM Socket Means 220. One non-limiting preferred retaining means is the use of a pin (219), preferably constructed from metal, and preferably held in place by a force means—a non-limiting example of which preferably may include a spring means (217). The part of the pin inserting into the plug is preferably round (see cross section K1-K2 of FIG. 5). Said pin preferably includes a lip (225) that in conjunction with barrier means (216) prevents said pin (219) from overextending into the cavity of socket means (220) when a plug is not inserted.

The LKM preferably includes a polarisation slot (253) to facilitate correct orientation of a plug into socket (220).

The LKM preferably includes one at least retraction means to facilitate retraction of pin (219) when one wishes to insert or remove a plug to/from the LKM. A non-limiting preferred example of a manual retraction means is to include a hole (218) in retaining means (219) and an access port (204) through the case of the LKM, preferably permitting a suitable retraction tool to be inserted and retracted by hand. A non-limiting example of said retraction tool (not shown) preferably includes a piece of wire bent into a right angle with one at least ends of the wire of a shape suitable for insertion into access port 204 and hole 218. Said retraction means is preferably metal and/or plastic and resilient enough to maintain its shape when a force is applied to remove retraction means 219 from the plug. The invention preferably allows for an automated retraction means.

The LKM is preferably constructed in part at least from resilient injection moulded plastic. It is preferable that part at least of the LKM includes metal and/or fibre reinforcing. Non-limiting locations for metal reinforcing preferably include the barrier means (216) and the part of the LKM (252) that provides leverage for the force means (217).

A non-limiting example of an LKM ID Means that preferably may not include an electronic component is represented by the human readable indicia (201) on the surface of the LKM. This preferably may be a non-automated means (eg if read by a human) and/or automated if read by machine means (eg. CMOS image sensor). In this example the indicia are two triangles—preferably colour coded. Said indicia are preferably printed onto the LKM and or applied as labels. Said labels are preferably manufactured from plastic and include a self-adhesive backing. It is preferable that the indicia means on the LKM matches that on the corresponding Lock ID Means and preferable that non-automated LKM LD Means may use any of the means previously described in this specification for non-automated Lock ID Means. It is preferable that one at least indicia means may illuminate. A non-limiting example of said illuminate preferably may include the use of ‘glow in the dark’ materials.

Human readable Lock ID Means and matching LKM ID Means (preferably multiple to allow for duplicate keys) are preferably produced and distributed as a unit. The Lock ID Means is preferably attached to the relevant lock and the LKM ID Means attached to the matching LKM(s)/Key(s).

The invention preferably allows for human readable indicia means to be read by automated means eg CMOS imaging.

Block drawing (200) of FIG. 4 shows the front surface of a non-limiting example of an LKM (6) suitable for coupling to a specifically manufactured key. The dotted line (203) outlines the part of the LKM (excluding key coupling means (214)) that overlies a centre plane parallel with said front surface of the LKM and passing through the centre of said LKM. Said centre plane are is shown in detail in block drawing (210).

It is preferable that part at least of the LKM occupies part at least of that portion of a key normally occupied by the material (eg metal) of the key handle of known art keys. As a non-limiting example, this may reduce the overall thickness and/or profile of a combination LKM/Key as compared with LKM's coupled to known art keys. The invention preferably allows for keys that do accommodate LKM's in this manner.

The key of block drawing (235) shows a key handle with a notch (236). The invention preferably allows for the process of manufacturing and/or distributing:—a) key blanks, and/or b) cut keys;
that include one at least notches (preferably of any shape) in part at least of the key handle that is open on one at least boundaries. It is preferable that said notch is coupled to a LKM restraining means to assist retainment of the LKM/Key coupling. A non-limiting example of said restraining means are the serration's (237) of block drawing (235).

The LKM preferably includes a key coupling means (214) to assist coupling with the LKM restraining means (237) of the key. In the present example coupling means (214) are a series of plastic fins.

The LKM is preferably coupled to the key by sliding it into the notch (236).

The reader is now referred to FIG. 5 of the drawings that show cross sections through various parts of the example LKM of FIG. 4. The voids (251) of the block drawings are preferably occupied by the coupled key. The numbers shown in FIG. 5 equate to the same parts described in FIG. 4.

It is preferable that the LKM is permanently bonded to the key by glue. The preferred glue is a two part mix. Part A is preferably applied at the time of manufacture of the LKM to the surfaces of the LKM that will make contact with the key. Part B is preferably an activator that is preferably applied at the time the LKM is to be coupled to the key.

Referring back to the block drawings of FIG. 4, other preferred non-limiting examples of means of coupling LKM's to keys specifically designed for said coupling are shown:—The preferred example of block drawing (295) shows a key with the LKM integrated into the handle of the key. This example shows the key in a cut format, however, it is preferable that integrated uncut blanks are distributed and cut using known art means. The preferred embodiment of this example includes a plastic key handle and metal key shaft.

The preferred example of block drawing 296 shows a key blank (289) (that in the drawing actually shows said blank in a cut state) that is preferably constructed of metal such that preferably after cutting, the key handle (292) may be broken off, preferably through areas of reduced thickness (290), leaving a key shaft (291) (preferably cut) with a coupling point (291a) for fixing to a key handle (293). Said key handle (293) is preferably constructed of plastic and preferably integrates an LKM. The coupled unit results in a preferably functional key (294). Said key shaft is preferably bonded to the key handle by glue.

Preferred non-limiting examples of LKM's suitable for coupling to prior art keys are now described with reference to FIG. 6 of the drawings. The electronics, LKM Socket Means and the retaining means 219 are preferably equivalent for LKM's intended to fit keys manufactured for the purpose and for LKM's intended to fit known art keys. It is preferably a change in the body of the LKM to permit it to attach to known art keys rather than fundamental changes in the basic principle. A non-limiting example of a suitable LKM 260 for known art keys is shown in block drawing 298 of FIG. 6. This is the view from the top surface of the LKM (the side where the LED raised section is located in cross section A1-A2). The drawing 260a shows components located inside said LKM 260 at the level of a plane drawn parallel to the LKM front surface 260 and through the centre of the LKM. The back surface of LKM 260 is shown as 260b.

Known art keys are produced in a plurality of styles. They have a plurality of different shaped handles, shaped holes and position of said holes as non limiting examples. One option may be to design a specific LKM to fit each handle design that one wants to target in the market. This may be problematic from an inventory perspective—both for the manufacturer and the retailer. It is preferable that at least one LKM 260 may be adapted to fit a plurality of different key handle designs by the use of a handle adapter means 270. Said adapter 270 is preferably a low cost plastic device (that preferably may include some reinforcing means eg carbon fibre, metal). It is preferable that an adapter may be produced to suit each key handle design that one wants to target in the marketplace.

The back surface 260b of LKM 260 is preferably shaped to fit together with at least a first handle adapter for a first key handle design and a second handle adapter for a second key handle design. The non-limiting example of handle adapter 270 shown in the drawings is designed to mate with the round handled key 3 used as a non-limiting example of key handle shapes in the drawings.

The back surface 260b of the LKM preferably has a first part 262a that steps down at 262 to a second part 262b. First part 262a preferably includes receptacle means 261. Said receptacle means preferably does not extend to the front surface 260 of the LKM. The position of said receptacle means 261 is shown as a dotted line on LKM front view 260. Said receptacle means 261 preferably mates with clasping means 271 on handle adapter 270. Said clasping means 271 preferably may be reinforced 272 (eg metal pin). The adapter means 270 preferably has a top edge 270a. It is preferable that top edge 270a and clasp means 272 are the same shape and position for at least a first handle adapter for a first key handle design and a second handle adapter for a second key handle design. Handle adapter 270 preferably has a first surface 273a that preferably steps down at line 273 to a second surface 275. Said stepdown 273 preferably is designed to fit the edge of a particular key handle design. Said adapter surface 273a preferably makes contact with said first part 262a of the back surface 262a of said LKM when the adapter and LKM are both applied to the appropriate key. Second part 262b of the back surface 260b of the LKM preferably makes direct contact with the key handle. Handle adapter second surface 275 preferably makes direct contact with the surface of the key handle opposite that contacted by LKM second surface 262b. Said second surface 275 preferably includes an elevated means, preferably plastic that is preferably shaped and positioned to fill the hole(s) in the target key handle.

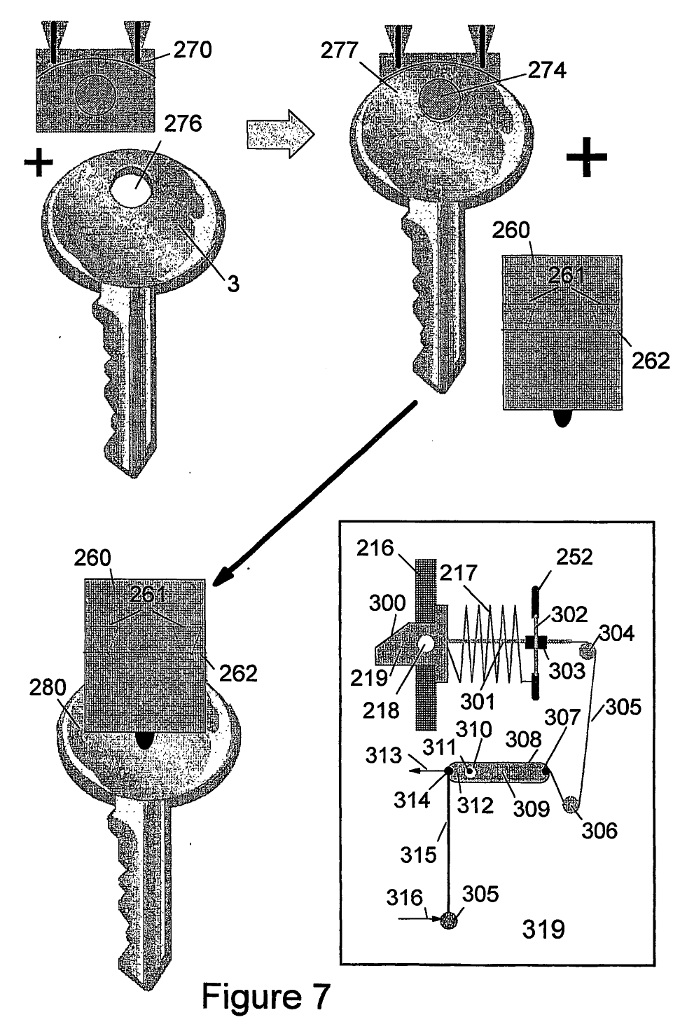

It is preferable that LKM 260 and handle adapter 270 are permanently bonded to the key by glue. The preferred glue is a two part mix. Part A is preferably applied at the time of manufacture to the surfaces that make contact with a means. Part B is preferably an activator that is preferably applied at the time of applying the LKM/Adapter to the key. FIG. 7 shows a non-limiting examples of the fitting of an LKM to a prior art key. Adapter 270 is preferably glued to a first surface of key handle 3 and means 274 fits through the hole 276 in said key handle. Means 274 preferably ends up flush with the opposite key handle surface. LKM 260 is then preferably glued to the other surface of the key handle and to adapter first surface 273a and adapter clasp means 271.

The preferred embodiment of LKM's described thus far show manual means for attaching and/or removing one at least LKM to one at least KGM Plug Means. It is preferable that the attachment and/or release of keys from a KGM plug means may be automated, preferably by the use of by the use of electronic means. Block drawing 319 of FIG. 7 of the drawings shows a preferred non-limiting example of said automated means. In the embodiment described the LKM is powered from a KGM in which case there is preferably no power to operate the automated the means of the invention during key attachment to a KGM Plug Means. Power is preferably present to facilitate automated removal of one at least keys from one at least KGM Plug Means. The invention preferably allows a power source to be coupled to one at least LKM to permit automated attachment of keys. The invention preferably allows that the automated means may be in part at least in said KGM Plug Means where power is preferably readily accessible, preferably facilitating the automated attaching and/or removal of one at least keys from one at least KGM Plug Means.

Block drawing 319 shows a somewhat similar means in part at least to that applying to manual plug coupling means previously described. The plug retaining means 219 is shown. This preferably has a means to facilitate manual insertion of KGM Plug Means. A bevel 300 on plug retaining means 219 is a preferred non-limiting example of a manual plug insertion facilitation means. Manual retraction hole 218 preferably may be left as a backup means. Retaining means 219 force means (eg a spring) 217 is also shown. Reinforcing means 252 is also shown, however, this preferably has an opening covered by a flexible waterproof membrane 302. Said membrane preferably seals the cavity containing force means 217 (that may be in contact with the environment, eg. through hole 218) from the electronics of the automated means. Force means 217 preferably keeps the retaining means 219 either in the LKM socket means 220 when no plug is present or couples (preferably snugly) with retaining means receptacle means in the mating KGM plug means. Retraction means 301 preferably couples through said membrane 302 with the means on the other side of said membrane 302. Passage of said retraction means through said membrane 302 is preferably reinforced by reinforcing means 303. A force is preferably applied to said retraction means 301 when it is required to detach the coupled key from said KGM Plug Means. Said retraction force is preferably applied by an electromechanical means. The preferred method is to use Shaped Memory Alloy (SMA). A non-limiting example of this is Nitinol wire. SMA wire has a property that enables it to change shape when heated. In the case of Nitinol, the wire will contract by approximately 2-4% when heated to a preferably predetermined temperature. Said heating is most efficiently obtained in the present embodiment by passing an electric current through SMA wire 315. Said wire is preferably attached to a fixed means 305 at one end and to a moveable means 314 at the other end. In this embodiment voltage is preferably applied via 316 and ground preferably returns via 313 to the system ground means. When heated to approximately 70 deg Celsius the wire 315 preferably contracts. Because the wire only contracts a small percentage of its length and because given the small confines of preferred embodiments of LKM's, said contraction length is limited and the amount of contraction may not be sufficient to move the retaining means 219 the required amount. It is preferable said SMA means 315 acts via a lever means 309 to magnify the movement of said retaining means 219. Said SMA wire is preferably attached at location 314 to the short arm 312 of the lever means 309. There is preferably an opening 310 in said lever means 309 at the location of the fulcrum 311. A preferably flexible coupling means 305 (preferably non-SMA wire) preferably attaches to the long arm 308 of lever means 309 at location 307. This is preferably directed by post means 306 and 304 to preferably couple with retraction means 301. It is preferable that when sufficient current is passed through SMA wire 315 for sufficient time that the contraction of said wire may remove the retaining means 219 from the corresponding receptacle in KGM plug means, preferably releasing said plug means. There is preferably one at least mechanical stop means (not shown) to limit movement of said lever means 309. These preferably may be coupled to micro switch means to prevent the SMA wire over contracting and/or overheating. The time power is applied to said SMA wire 315 is preferably limited to a preferably predetermined period by electronic means coupled to the invention.

One preferred non-limiting means of applying power to said SMA wire 315 is to include a second onewire switch means (eg a second DS2405 or a DS2406 with two outputs) in said LKM and enable this under the control KCM means (eg as for activating illumination means 202) when a user wishes to remove one at least keys from one at least KGM. Another preferred non-limiting means of activating the automated key removal means is to have the voltage input means accessible at the surface of the LKM and to apply a voltage directly to said accessible means (eg KCM may have a means to provide said voltage by manual physically coupling said KCM voltage means to said LKM voltage input means). The method described for releasing the retaining means of an LKM preferably may have application to other latching means, especially where space is a premium. The SMA means described for the present embodiment preferably may be used, as non-limiting examples, in automated garment closures and in particular those described in copending PCT/AU03/00769 relating to automated removal of garments and already incorporated by reference.

It is preferable that part at least, of one at least LKM, may be coupled to one at least keys after manufacturer of said key. Non-limiting examples of said after manufacture preferably include by the:—consumer, and/or manufacturer, and/or wholesaler, and/or retailer (eg the business that cuts keys). It is preferable that part at least of one at least LKM may be coupled to one at least keys during manufacture of said key.

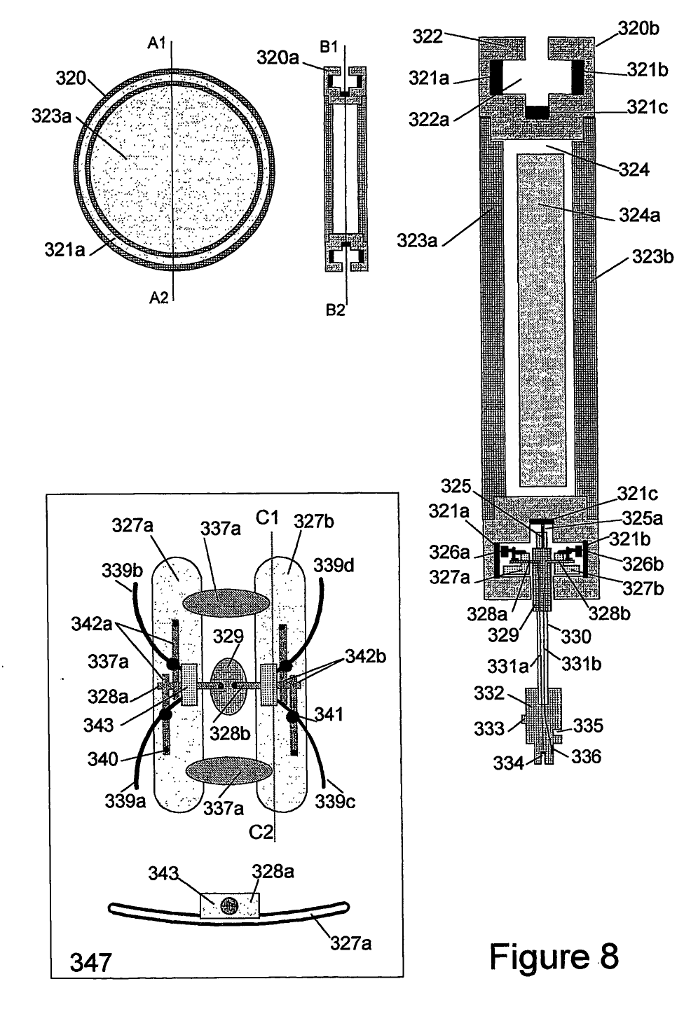

The reader is now referred to FIG. 8 of the drawings that may facilitate understanding the description of a non-limiting preferred embodiment of part at least of the Key Grouping Means (KGM) 320. The prior art describes a plurality of Key Grouping Means to collate and retain one at least keys. The Key Ring is a probably the most popular KGM of the prior art. It is cheap and it has the distinct advantage that when a key is selected by a user for actioning a lock, the balance of the keys and/or other attached means (eg key tag) preferably slide around the ring under the influence of gravity and out of the way of the key intended for use. The key ring is a flexible and useful device. Unfortunately it is not easy to distribute electrical power and/or signals to keys (especially to a plurality of keys) attached to prior art key rings. Prior art means attached to key rings that require a power means, are usually required to be coupled to their own power means. A non-limiting objective of the present invention is to describe Key Grouping Means that preferably a) continued with the preferably circular theme of a key ring, and b) preferably permitted keys to continue to fall away from one at least other keys under the influence of gravity (and/or other means), and c) that preferably could deliver power and/or electrical signal to one at least keys and/or other means attached to one at least KGM. It was another objective of the invention to preferably make provision for a battery means in said KGM and preferably to include and/or make provision for one at least electronic means in part of one at least KGM. The preferred embodiment of a KGM describes three conductors as a non-limiting example.

The prior art describes key wallets and/or pouches and/or similar means wherein the keys relatively fixed in position and preferably hinged and/or slid out as required. The means of distributing electrical conductors to this type of KGM is relatively simple compared to an electrical conductor system to keys collated on a means that preferably preserves part at least of the functionality of prior art key rings. Those experienced in the art should be able to adapt the means of the invention to one at least other known art key grouping means.

It is preferable as non-limiting example, that the means of the invention may be applied in part at least to one at least LKM's that includes its own power means and wireless communications wherein said one at least LKM's may be coupled to known art key grouping means.

Key Grouping Means suitable for use with the invention are preferably not limited.

Diagram 320 of FIG. 8 shows an inside view of a preferred embodiment of one at least KGM obtained by drawing a plane coming out of the page through line B1-B2 of view 320a of said KGM. KGM view 320a is a cross section through view 320 formed by a plane coming out of the page through line A1-A2. The size of one at least KGM is preferably not limited, however, the size shown in said KGM view 320 is preferably an approximation of the size of one preferred embodiment. Said KGM 320 is preferably a thin disc (eg approximately 10-12 mm, as a non-limiting example) with a track means 322 around the circumference of said disc. Said track means 322 preferably may accommodate one at least sled means as shown as a non-limiting example in block drawing 347. Said sled means 347 preferably may carry one at least KGM Plug Means and preferably facilitate coupling of KGM conducting means (321a and/or 321b and/or 321c) with KGM Plug conducting means (eg 331a and 331b). Said sled means 347 preferably may slide under the influence of gravity (and/or other forces) around track means 322. Said sled means 347 preferably physically fits in the void means 322a formed by track means 322. Said track means preferably has a first electrical conductor means 321a extending the circumference of one side of the track means and a second electrical conductor mean 321b extending the circumference on the other side of the track means 322. As a non-limiting example it is preferable that conductor means 321a is the positive voltage means of the onewwire system described in this specification and conductor 321b is the return line of power means to coupled to said KGM. It is preferable that for many means coupled to one at least KGM that the conductors 321a and 321b will suffice and this is the case for one at least LKM embodiments described in this specification.

The number of electrical conductor means coupled to one at least KGM is preferably not limited, however, it is preferable that a third electrical conductor 321c is included in the present embodiment. Non-limiting applications of said third conductor preferably include use as a system Vcc supply to preferably avoid potential problems with a two wire system that may pull and/or attempt to pull the Vcc line low to transfer data using said onewire means.

It is preferable that the void 324 shown in the preferred embodiment may be used, as a non-limiting example, to accommodate a battery means 324a. The positive terminal (eg Vcc) of said battery is preferably applied directly and/or indirectly to said third conductor 321c. It is preferable that Vcc on said third conductor 321c may provide battery Vcc to Key Control Means (eg Key tag), and/or one at least KGM and/or one at least other means coupled to one at least KGM and/or KCM.

It is preferably that auxiliary power means coupled to the means of the invention may apply power directly and/or indirectly to said third conductor 321c. Said applied auxiliary power preferably may be used to power means of the invention. Said applied auxiliary power preferably may be used to recharge one at least batteries coupled to the means of the invention.

One at least sides (323a and/or 323b) of KGM 320 are preferably reversibly attached. to the body of said KGM. Said attachment preferably may use known art means (eg a screw means, clip means) and are not depicted in the drawings. The means of connecting power means to one at least electrical conductors (eg 321a and/or 321b and/or 321c) are known to the art and not depicted in the drawings. It is preferable that one at least electronic means (not shown) may be included and/or added to one at least KGM.

It is preferable that a microprocessor means and/or memory storage means may be installed in one at least KGM. It is preferable that one at least onewire interfaces may be installed in one at least KGM. It is preferable that said microprocessor means may use said onewire interface to communicate with one at least coupled KCM's (eg key tag); and/or one at least other KGM's electrically attached directly and/or indirectly to said KGM; and or to one at least other means (eg LKM's) coupled to the onewire means. One at least KGM preferably may include an electronic ID means that is preferably unique to said KGM. Said ID is preferably programmed into said microprocessor means.

One at least KGM preferably has a KGM Illumination means (eg LED), preferably visible to an observer. Said LED preferably may be addressed (eg via said microprocessor means) and illuminated to facilitate selection of said KGM from a plurality of KGM's.

It is preferable that a RF Wireless Communication means may be installed in one at least KGM. Said RF means preferably may be used to communicate, as non-limiting examples, with one at least KCM's and/or one at least KGM's and/or one at least KGM Storage Means.

The invention preferably allows that one at least of the means described for one at least KCM may be incorporated into one at least KGM's. The preferred location for cellular telephone means and/or GPS incorporated into the means of the invention is as part of the means of one at least KGM.

It is preferable that electronic means installed in one at least KGM are incorporated in part at least into one at least sides (323a and/or 323b) of said KGM 320. Said incorporation preferably includes a suitable RF shielding means.

The preferred means for connecting KGM electronic means to power means and/or of connecting electronic means in side 323a with those in side 323b is by known art electronic connector means—preferably spaced around the void 324 adjacent to track means 322.

FIG. 8 shows a preferred non-limiting example of a KGM plug means 322 that preferably may mate with one at least LKM Socket means 220 previously described with reference to the drawings. Said plug means 332 preferably includes a polarising tag to mate with the matching polarising slot 253 on said LKM. It preferably includes a receptacle means 335 for retaining means 219 on said LKM A power socket 334 is preferably provided to mate with power pin means 222a on said LKM and a ground connection 336 to mate with ground means 215 on said LKM. Said plug means 332 is preferably coupled to a cable means 330. Said cable means 330 is preferably resilient and/or flexible and preferably includes one at least electrical conductors (eg power conductor 331a and ground conductor 331b). Said cable 330 preferable terminates in a rigid and resilient termination means 329 (preferably plastic) that preferably encloses the junction between conductors 331a and 3331b and sled interface means 328a and 328b. Said sled interface means are preferably electrically conducting, are preferably round in cross section, and preferably are accommodated by a mating hole in sled ski upright 343 and preferably may rotate inside said mating hole. Sled skis 327a and 327b preferably maintain the orientation of the sled means in the track means. Preferably resilient conducting means 326a (eg phosphor-bronze, preferably gold plated) preferably provide electrical continuity between track conducting means 326a and conducting sled means 328a. Preferably resilient conducting means 326b (eg phosphor-bronze) preferably provide electrical continuity between track conducting means 326b and conducting sled means 328b. The plug/sled arrangement described with reference to cross section 320b of FIG. 8 preferably meets the electrical and mechanical coupling requirements of one at least LKM's. It is preferable that an extension to the described means may be available for plug means (referenced as 3× Plug Means) that need to interface with said third conductor 321c. Said extension preferably provides an additional support 325 to termination means 329 and a preferably flexible conductor means 325a (preferably metal eg phosphor-bronze) designed to maintain contact with conductor 321c. Although not shown in the drawings said 3× plug means is preferably adapted (eg additional power socket) to provide coupling for said third conductor 321c to means coupling to said 3× Plug Means. One non-limiting application for a 3× plug means is preferably to couple one at least Key Control Means (eg Key Tag) to one at least KGM. A means to couple a KGM/KCM to a person (eg to a hook on a belt) is preferably coupled to one at least means of the invention. The preferred means is to have a metal ring coupled to one at least termination means 329 by a resilient and flexible cable and said termination means 329 is preferably also coupled to a 3× Plug Means that may be coupled to one at least KCM. Another preferred non-limiting application for said 3× Plug Means is to couple one at least second KGM to one at least first KGM.

The drawings show one KGM Plug Means 332 and attached cable 330 coupled to one sled means 347. The number of said plug means and/or said cables coupled to one sled means is preferably not limited. It is preferable that one at least KGM may be opened (eg along plane drawn through line B1-B2) to allow access/cleaning/upgrading of means coupled to the track means 322. It is preferable that part at least of conducting means coupled to one at least KGM may be plated eg gold and/or nickel.

Block drawing 347 shows a prefered non-limiting example of a sled means. It is viewed from above the sled means inside the KGM looking out of said KGM. It preferably includes sled skis 327a (supporting the Vcc means) and 327b (supporting the ground means). The sled skis are preferably joined by transverse members 337a and 3337b. The top of termination means 329 is shown. Sled interface means 328a (vcc) and 328b (ground) are shown. These preferably emerge from termination means 329 and turn at approximately 90 degrees enabling them to be located in holes in sled ski uprights 343. Sled interface means 328a and 328b preferably provide a conducting and mechanical support means to one at least KGM Plug Means. Power is preferably coupled to the sled 347 by KGM conductor coupling means 339a and 339b for Vcc; and 339c and 339d for ground. Said conductor coupling means 339 are preferably anchored by sled ski uprights 343 and are preferably resilient and flexible and preferably designed to maintain contact with KGM conductor means (eg 321a and/or 321b and/or 321c). Said conductor coupling means 339 are preferably manufactured from gold plated phosphor-bronze as a non-limiting example. A sled coupling conductor means 342a (vcc) and 342b (ground) are preferably anchored to ski 327a and 327b respectively by connecting means 340. Said 342 are preferably designed to preferably make and maintain contact with sled interface means 328a and 328b respectively, while preferably allowing said sled interface means to rotate. Continuity between conductors 339 and 342 is preferably by electrical join 341 (eg laser spot weld). The sled skis are preferably curved (see cross section through line C1-C2) to match the curve in the track means of the coupled KGM.

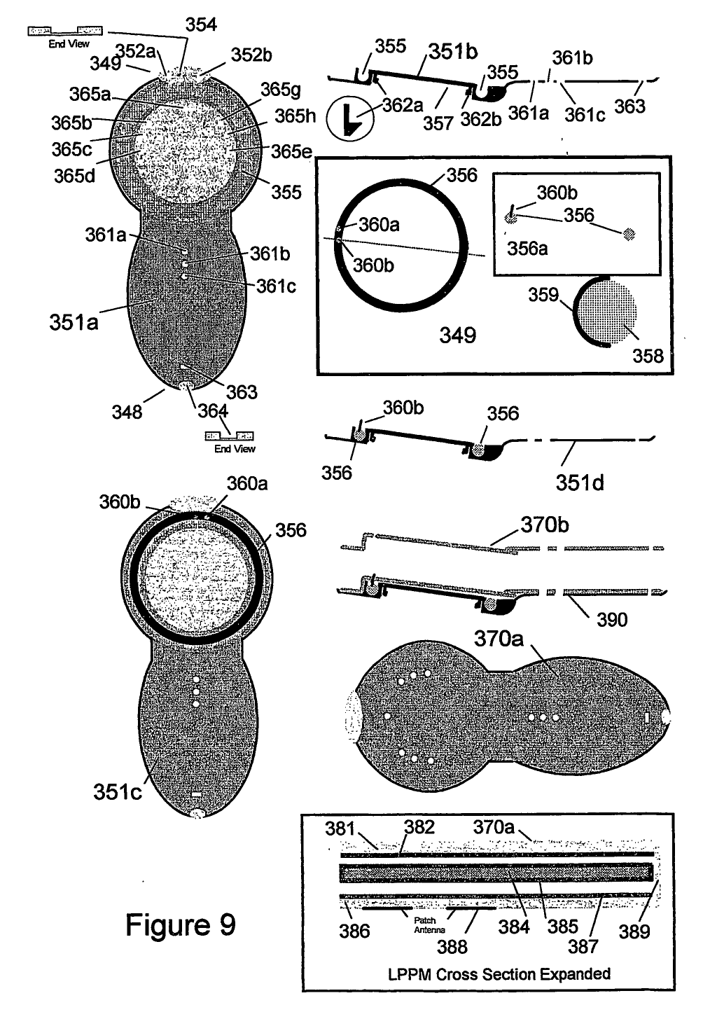

Key Control Means. The reader is now referred to FIG. 9 of the drawings that may facilitate understanding the description of a non-limiting preferred embodiment of part at least of the Key Control Means (KCM) 1. Said embodiment is preferably included in the Key Tag 350. Part at least of means described for a key tag embodiment of a KCM preferably may be included in other embodiments of Key Control Means (KCM). The key tag 350 is preferably constructed of a front and back shell. The front shell of the key tag in this non-limiting example is that which includes the display and/or keyboard. The back shell 351 is preferably that which includes the RFID Reader Antennae. The KGM end 348 of said tag is preferably that which couples to the KGM. The remote interface end 349 is preferably opposite to said KGM end 348 and preferably includes a) an infrared emitter to control, as non-limiting examples:—TV, VCR, set top boxes; and/or b) an IrDa means as non-limiting means.

The back shell 351 of the key tag is preferably manufactured in part at least from injection moulded plastic. It is preferable that said back shell 351 includes an outer enclosure 351a The outer enclosure as depicted in 351a of the drawings is viewed from the inside surface. The internal surface of the outer enclosure 351a is preferably subsequently bonded in the manufacturing process to other parts of the back shell where applicable. Said other parts preferably provide shielding against EMF radiation. Said outer enclosure 351a is preferably transparent to radio waves and preferably may be manufactured from one at least transparent and/or coloured materials. A cross section through the long axis of outer enclosure 351a is shown as 351b.

The invention preferably allows for wireless communication to and/or from the KCM and one at least remote means. A non-limiting example of said wireless means preferably includes infrared means. Non-limiting examples of said remote means preferably may include one at least of TV Remote Control Means, VCR Remote Control Means, DVD Remote Control Means, Audio Means Remote Control Means, Set Top Box Remote Control Means, User Controlled Data Processing Means (UCDPM); Internet connected means. A non-limiting example of said Infrared Communication Means (ICM) preferably includes an Infrared Emitter Means that preferably may be pulsed (eg known art TV remote controller) by means coupled to said KCM to control one at least said Remote Means. Another non-limiting example of said ICM preferably includes IrDa Means. The outer enclosure 351a preferably includes a moulding 354, preferably at the remote interface end, to accommodate one at least Infrared Communication Means.

The invention preferably includes a means to reversibly attach one at least Key Grouping Means (KGM) means to one at least KGM Storage Means (as a non-limiting example, a wall mounted unit to which one at least keys and/or one at least KGM may be reversibly attached). A preferred option is to include one at least openings in one at least parts of the apparatus of the invention to facilitate said reversible coupling with said KGM Storage Means. The preferred embodiment includes two holes (352a & 352b) to facilitate reversible attachment to said KGM Storage Means. It is preferable that the invention allows for a means to automatically identify one at least KGM. It is preferable that said KGM automatic identification means may be used, as a non-limiting example, to identify one at least KGM Storage Means attached to one at least KGM Storage Means. It is preferable that the automatic identification means includes electronic means. The preferred electronic means preferably may use a Dallas Semiconductor Onewire DS2401 and/or DS2405, the data sheets of which are included by reference elsewhere in this specification. It is preferable that there is a KGM Indicator means to facilitate selection of one at least KGM. It is preferable as a non-limiting example that activation of said indicator means (eg LED illuminating) may be used to facilitate selection of one at least KGM from a plurality of KGM, and/or said indicator means may be used to facilitate identification of one at least KGM. It is preferable that the invention allow that part at least of the means of the invention described for selecting and/or identifying keys/LKM's may be applied to selecting and/or identifying one at least KGM.

It is preferable that there is a means for external means to access the KGM automatic identification means. A preferred non-limiting method is to include a conducting means 353a coupled to hole 352a and a second conducting means 353b coupled to hole 352b. As a non-limiting example, VCC of said DS2405 may be coupled to the conductor 353a and ground of device DS2405 coupled to the conductor 353b. Each KGM preferably has its own unique (at least in practice) ID.

It is preferable that there is a means to recharge (where applicable) batteries coupled to one at least KGM when said KGM is reversibly attached to one at least KGM Storage Means. The preferred means of said recharging preferably may include driving the VCC on conductor 353a at a slightly higher voltage than required for one wire access yet still within the device limits, with means within the KGM preferably included to detect said higher voltage and activate recharge means if applicable.

One non-limiting preferred means of a user communicating to one at least KCM which lock(s) they may wish to find/select a key(s) for is by reading Lock ID Means using RFID Means. The use of an RFID Means as part of a Lock ID Means has already been described in this specification. Accessing this information from said Lock ID Means may require a RFID Reader. It is preferable that said RFID Reader is part of one at least KCM that is preferably located in part at least in one at least Key Tag Means. Said RFID reader usually requires an antenna means. It is preferable that outer enclosure 351a includes a moulding 355 to accommodate said RFID antenna means.

The key tag 350 (and/or other KCM) preferably physically attaches to the KGM. Said KCM Attachment Means is preferably mechanically resilient and/or flexible and preferably includes electrical conducting means. Said attachment is preferably reversible. The attachment means is preferably a flexible cable means. Said cable preferably includes electrical conducting means and mechanical connecting means. The KCM/KGM coupling means preferably includes a connector means at the KCM end and a KGM coupling means at the other end. The outer enclosure 351a preferably includes a moulding 364 to facilitate attachment of the key tag means 350 with the KCM End of said KCM/KGM coupling means.

It is preferable that decorative enclosure means may be attached to part at least of the external surfaces of key tag 350. Said decorative attachment is preferably reversible. Said attachment and/or detachment preferably includes automated means, referenced as Decorative Enclosure Automated Coupling Means. The invention preferably allows that attachment of a decorative enclosure may use any known art means automated and/or non-automated. It is preferable that there is a means for the KCM to control said automated attachment/detachment. It is preferable that there is an opening 361a in the key tag 350 enclosure to permit an electrical return conductor (eg ground) between automated means in said decorative enclosure (and/or other external means) and means within said key tag 350. It is preferable that there is an opening 361b in the key tag enclosure 350 to permit a conductor for power means (eg Vcc) to pass to automated means coupled to said decorative enclosure to facilitate said automated attachment/detachment. It is preferable that means coupled to the KCM (preferably in response to user input that attachment and/or detachment of the decorative means is required) apply voltage/current to said power conductor means to facilitate said attachment/detachment.

The invention preferably allows for one at least Accessory Function Means (AFM) (eg camera and/or external battery as non-limiting examples) to be coupled to one at least KCM and/or key tag means. It is preferable that said AFM may be attached directly to the KCM (eg key tag 350) enclosure. It is preferable that said AFM may be coupled to said decorative enclosure (preferably to an external surface of said decorative means). It is preferable that said decorative enclosure passes through any electrical and/or optical conducting means used to couple said AFM with said KCM. Said AFM attachment is preferably reversible. Said attachment and/or detachment preferably includes automated means, referenced as AFM Automated Coupling Means. The invention preferably allows that attachment/detachment of one at least AFM may use any known art means automated and/or non-automated. It is preferable that said AFM may use the same return line passing through opening 361a. It is preferable that there is an opening 361c in outer enclosure 351a to permit a conductor for power means (eg Vcc) to pass to automated means coupled to said AFM, to facilitate said automated attachment/detachment. It is preferable that means coupled to the KCM (preferably in response to user input that attachment and/or detachment of the AFM means is required) apply voltage/current to said power conductor means to facilitate said attachment/detachment. It is preferable that there is an indentation 357 (see side view 351b) in the external surface of outer enclosure 351a to facilitate coupling of one at least AFM Attachment of said AFM is preferably facilitated by one at least clasp means (eg 362a & 362b) that preferably mate with matching clap receptacle means on one at least AFM enclosures. Attachment of said AFM is preferably facilitated by one at least clasp means coupled to said AFM that preferably mate with one at least key tag based clasp receptacle means via opening 363 in the outer enclosure 351a. The invention preferably allows for electrical and/or optical conducting means (referenced as AFM interface means) to interface one at least KCM with one at least AFM. The outer enclosure 351a preferably includes openings (eg 365a, 365b, 365c, 365d, 365e, 365f, 365g) to facilitate said AFM interface means. Non-limiting examples of said AFM interface means preferably include Gnd (eg via opening 365a), Vcc (eg via opening 365b), Data Into KCM (eg via opening 365c), Data Out of KCM (eg via opening 365d); Clock (eg via opening 365e), Valid Data Out (eg via opening 365f) and Valid Data In (eg via opening 365g).

It is preferable that one at least electrical conducting means on one at least external surface of key tag 350 are protected against accidental contact and/or shorting. The preferred method of protection is to mechanically recess said electrical contacts.

Non limiting examples of RFID Reader Antenna 356 (also shown in cross section 356a) preferably may include coiled insulated (eg enamelled) conductor 358 wound the appropriate number of turns. Said winding is preferably on a coil former 359 (that preferably includes a plastic component). It is preferable that each end of said coil 360a and 360b are positioned to enable them to interface with RFID Reader Electronics. Another non-limiting example of a suitable antenna preferably may include traces on a PCB. In this example the ends of the antenna preferably connect via printed traces to Reader Means also attached to said PCB. Block drawing 351c shows the outer enclosure 351a with the antenna 356 mounted. A cross section is shown as 351d.

It is preferable that the enclosure of the KCM prevents unwanted RF emissions. The invention preferably allows for any known means non-limiting examples of which preferably may include metal shielding and/or conductive plastics. The preferred method is the use of a Laminated Plastic Protective Means (LPPM) to enclose electronics that are likely to be a source of problem RF. It is preferable that the use of discrete metal shielding may be dispensed with in this arrangement. It is preferable that said LPPM may also incorporate part at least of antenna means required by the KCM, with the preferred means of manufacturing antenna being patch antenna applied to one at least plastic laminates of said LPPM. It is preferable that the KCM enclosure includes one at least Posterior LPPM 370 to shield the underside (as viewed from the front of the KCM) of electronic components, and one at least Anterior LPPM to shield the topside of electronics components. The internal surface of the posterior LPPM is depicted in the drawings as 370a and a cross section through the long axis is shown as 370b. In the present embodiment the posterior LPPM is preferably glued (and/or otherwise attached) to the Outer Enclosure 351a already described, to form the back shell 351 of the KCM enclosure that is shown in longitudinal section in 390. It is preferable that the inner surface of the Posterior LPPM includes suitable mouldings to accommodate various devices (eg Java button, PCB, Function Modules)—these mouldings are not depicted in the drawings and are obvious to those knowledgeable in the art. The patch antenna may also require openings through part at least of the laminates of said Posterior LPPM to permit electronic device means (eg within the enclosure) to be coupled to said patch antenna—for the sake of clarity these openings and their positions are not depicted. The invention preferably allows for any known art of antenna design to be incorporated into the KCM and in particular patch antenna design. These methods are well known to those versed in the art and in particular those familiar with the design of patch antenna on cellular phone enclosures. It is preferable that one at least of the following aerial means may be included in the KCM (preferably as patch antenna in part at least):—a) antenna suitable for use in one at least frequencies used to lock/unlock motor vehicles; b) antenna suitable for use with one at least frequencies used to open/close garage doors; c) antenna suitable to read the RFID emissions sent to a vehicle key means and to transmit the required radio frequency to said RFID; d) antenna suitable for bluetooth transmissions; e) antenna suitable for 802.11b transmissions; f) antenna suitable for zigbee transmissions; g) antenna suitable for cellular telephone means; h) GPS antenna means. The invention preferably allows that part at least of the antenna means of the invention may be fabricated with other parts of the invention, a non-limiting example preferably including the Key Grouping Means (KGM).

The preferred structure of an LPPM is shown in the expanded cross section of a Posterior LPPM 380 of FIG. 9 of the drawings. This shows an inner layer 381 of preferably non-conductive plastic forming the inner surface 381a that is preferably coated with a preferably metallic conducting layer 382 on the outer surface of said inner layer 381. A central layer 384 of preferably conducting plastic is preferably coated on both sides and all ends and openings with a metallic coating 385. The metallic coating is preferably thick eg up to 50 microns. The preferred means of applying said thick metallic coating is known to the prior art. The outer layer 386 is preferably of non-conductive plastic on the outer surface 386a with a metallic coating 387 on the inner surface. It is preferable that where applicable patch antenna are fabricated on the outer surface 388 of said outer layer 386. The outer layer preferably includes mouldings 389 that fit into openings in the LPPM to insulate conductors passing through said openings from contact with conductive surfaces in said opening. It is preferable that the inner surface 381a and/or the outer surface 386a may include conducting areas. One non-limiting application of said conducting areas may be to facilitate coupling of other shielding means to the shields of the LPPM. The various layers of the LPPM are preferably laminated together using known art means (eg glue that is preferably conductive where applicable). The LPPM means described with reference to FIG. 7 of the drawings preferably may have applications with other small enclosures for electronic means (eg one at least of cellular phones, cordless phones, PDA, MP3 players as non-limiting examples). The LPPM means described for use with a KCM (eg key tag) enclosure preferably may be applied to other parts of the invention (eg KGM and/or LKM as non-limiting examples).

The electronics of the KCM are preferably constructed on one at least printed circuit means and attached by known art means to the inside surface of the back shell 351 of the key tag. The preferred functions of one at least KCM have been described in part at least in this specification. It is preferable that one at least functions may be shipped with the KCM and/or one at least functions added subsequent to manufacture. The means of constructing an appropriate electronic means that is preferably able to be upgraded by the user are well known to the prior art. Said electronic means may not be described in detail as the required method and apparatus should be readily apparent to one experienced in the art, given the information provided in this specification.

It is preferable that KCM electronics include a RFID Reader Means to read and/or write information to RFD transponder means coupled to Lock ID Means. The invention preferably does not limit the RFID transducers that the reader means may access (non-limiting examples preferably may include RFID transducers used in animal ID, and/or transducers used to code groceries). A non-limiting example of a suitable reader means preferably may be based around the EM4095 chip from EM Microelectronics. The RFD reader/writer preferably interfaces to and may be controlled by a microprocessor means coupled to the KCM electronics.

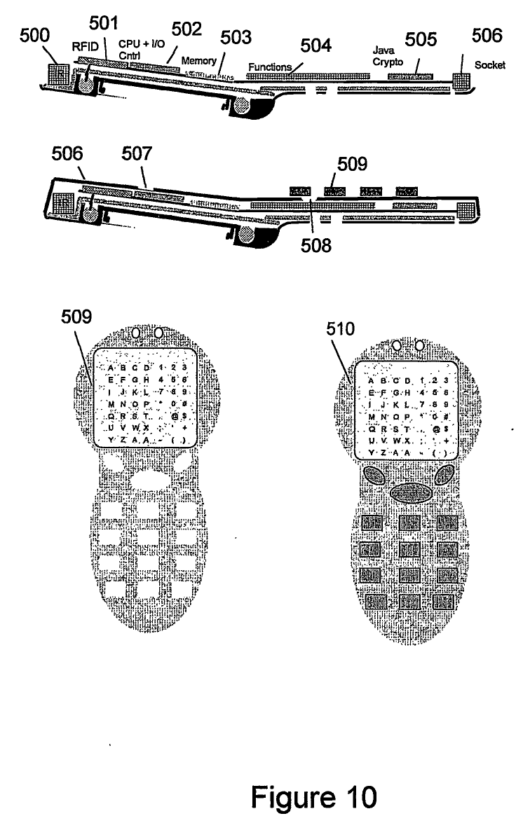

FIG. 10 of the drawings shows a non-limiting example of a preferred arrangement for part at least of electronic devices that preferably may be include in said KCM. IR means 50000, RFID chips 501, CPU and I/O means 502, memory 503, other functions 504, Java cryptobutton 505; socket to couple with KGM 3× plug means.

The anterior RF shield (eg LPPM) 506 is preferably fabricated on top of the preceding. The openings are preferably minimised eg; display interface opening 506 and keyboard interface opening 508. The keyboard 509 is preferably located above said shield 506. The top cover 509, preferably including display means is preferably the final addition to a complete KCM (in this example key tag) 510.

It is preferable that the KCM electronics include a sound output means (not shown). The preferred device being one at least piezoelectric means used by cellular telephone manufacturers.

It is preferable that the KCM electronics include a sound input means (not shown). The preferred means is one of the sound input means used in cellular telephones. An electret microphone is a preferred non-limiting example of a sound input means.

The hardware described preferably provides considerable flexibility for appropriate software to implement plural functions.

It is preferable that one at least KCM includes a database and/or other library means of one at least LKM ID Means that preferably may cross reference one at least Lock ID Means of lock(s) the key coupled to said LKM may action. As a non-limiting example, a user preferably may load an LKM ID into one at least KCM. This is preferably by coupling said LKM to the means of the invention. One at least KCM preferably include a probe means (preferably retractable) that may be inserted into LKM to read LKM ID Means. When first creating a database the user preferably takes one at least keys and reads in the ID information. They are then preferably asked to enter the coupled Lock ID. This preferably may be the electronic Lock ID. This preferably may be entered by scanning said Lock ID Means with the RFID reader coupled to said LKM (and/or other electronic means). They user preferably may be asked to enter one at least LKM Key Description Means about Lock ID (eg description of object coupled to said lock, GPS co-ordinates). These are preferably stored in said database means. Data entry is preferably one at least of the means described for the invention.

To enter information for keys coupled to one at least KGM, the user preferably may enter one at least keyboard entries that sequentially illuminates coupled keys and enter a second key to indicate that a particular key is the one to enter and/or retrieve information for.

The KCM preferably scans all coupled keys (preferably on a periodic basis and/or in response to a user command) and logs their LKM ID Means automatically. It is preferable that there is a menu option to scan through coupled keys.

Once information has been entered into said KCM it is preferable that by entering one at least LKM ID Means eg electronically reading LKM's and/or manually entering information (eg keyboard, voice, menu selection) it is preferable that the user may retrieve one at least types of Lock ID information and/or LKM Key Descriptor information.

It is preferable that one at least KCM may accept a Lock ID Means and provides descriptive information about the key(s) that action said lock.

When a user wants to locate a key coupled to a KGM, it is preferable that they read the Lock ID Means electronically and/or enter other descriptive information about the (and/or its coupled objects) lock into one at least KCM. The KCM preferably checks its database. If the appropriate key is on the relevant KGM and there is a match for it against the Lock ID Information entered, the KCM preferably illuminates the LED coupled to said key. Said illumination time and/or intensity is preferably programmable by the user.

The KCM preferably prompts the user to enter Lock ID information when it has a LKM ID information stored without one at least matching Lock ID data and/or LKM Key descriptor information for said lock(s).

When the user has an unattached key that they require Lock information for they preferably couple it to one at least KCM and if said KCM has the relevant information it preferably transfers this to said user (eg speaker means and/or display means).

It is preferable that KCM databases may be updated and/or edited. It is preferable that a first KCM may transfer part at least of its stored information to one at least other KCM. It is preferable that a first KCM may receive stored in formation from one at least second KCM's. It is preferable that input data may be amalgamated with existing stored information (eg key ID and/or lock ID Means as non-limiting examples). It is preferable that part at least of said amalgamation may be automatic. It is preferable that part at least of said amalgamation may be under user control.

It is preferable that part at least of information stored in one a least databases and/or other library means coupled to one at least KCM may be transferred to and/or from a personal computer means and/or other mass storage means and/or Internet means. It is preferable that input data may be amalgamated with existing stored information (eg key ID and/or lock ID Means as non-limiting examples). It is preferable that part at least of said amalgamation may be automatic. It is preferable that part at least of said amalgamation may be under user control.

The invention preferably allows for personal computer based and/or Internet based programs to prepare and/or edit information pertaining to keys and locks for subsequent loading into one at least KCM's.

It is preferable that part at least of transferred data may be in encrypted format.

The invention preferably allows for one at least service providers to provide a backup service for Lock and/or key information

One at least KCM preferably may includes means to store and/or edit key information into one at least LKM's and/or Lock ID Means.

One at least KCM preferably may include software to operate the automated key attachment and/or detachment means of the invention.

It is preferable that there is a Key ID Comparison Means wherein one at least LKM ID Means is preferably input to said Key Control Means and preferably compared (as a non-limiting means) with one at least LKM ID Means previously stored (eg using Key ID Edit Means) within said KCM Key ID Storage Means. It is preferable that said Key ID Comparison Means includes one at least of:—
a) Means to determine and/or output the descriptive information linked to said previously stored LKM ID Means when said LKM ID Means matches said Input LKM ID Means;
b) Means to output information that no match for said Input LKM ID was found;
c) Means to output information that no descriptive information is linked to said previously stored LKM ID Means.

It is preferable that said key description means may include data stored in electronic format that is representative of one at least ASCII sequences describing said key function. It is preferable that said ASCII sequence may be used, as non-limiting examples to:—

Display a human readable message on display means (eg, LCD) coupled to said key control means; and/or Reference a sound library that may be used to produce an analogue signal, that may cause a speaker means coupled to said control means to output sound that describes said key function.

It is preferable that said key description means may include data stored in electronic format that is representative of one at least digital sequences (eg as obtained from a sound digitizer) that may be supplied to a D/A converter to produce analogue output that may cause a speaker means coupled to said control means to output sound that describes said key function.

It is preferable that there is a Key Description Comparison Means wherein one at least Key Description Means is preferably input to said Key Control Means and preferably compared (as a non-limiting means) with one at least Key Description Means previously stored (eg using Key Description Edit Means) within said KCM Key ID Storage Means;

It is preferable that said Key Description Comparison Means includes one at least of:—
a) Means to determine that the comparison between, said Input Key Description Means and said Previously Stored Key Description Means, is valid and If valid, preferably a means to determine the LKM ID Means linked to said Previously Stored Key Description Means; and a means to signal the LKM that is linked to said LKM ID Means that it should illuminate.
b) Means to output information that no match for said Input LKM ID was found;
c) Means to output information that no descriptive information is linked to said previously stored LKM ID Means.

It is preferable that there is a KCM Password Means to password protect access to one at least functions provided by said key control means.

It is understood that variations in the figures or described elsewhere in this specification are for illustrative purposes only and that many other variations will be apparent to one skilled in the art. It will also be understood that the specification and figures are illustrative of the present invention and that other embodiments within the spirit and scope of the invention will suggest themselves to those skilled in the art.

1. The method of physically coupling a device that includes an electronic means to one at least keys.

2. The method of claim 1 wherein said coupling is maintained in part at least when said one at least keys is not attached to a key grouping means.

3. The method of claim 1 wherein said electronic means is coupled in part at least after manufacture of said one at least keys.

4. The method of claim 1 wherein said electronic means includes one at least address decoding means.

5. The method of claim 1 wherein said electronic means includes one at least indicator means.

6. The method of claim 5 wherein said indicator means includes one at least illumination means.

7. The method of claim 1 wherein said electronic means includes one at least electronically readable ID means.

8. The method of claim 7 wherein said ID means facilitates the identification of one at least locks that said one at least keys is able to action.

9. The method of claim 7 wherein said ID means facilitates the selection of one at least keys from one at least other keys.

10. The method of physically coupling one at least electronically operable and/or addressable indicator means to one at least keys.

11. The method of claim 10 wherein said indicator means is used to facilitate selection of one at least first keys from one at least second keys.

12. The method of claim 10 wherein said indicator means is used to facilitate inputting and/or outputting of information pertaining to use of said one at least keys.

13. The method of claim 10 wherein said indicator means is a component part of one at least Local Key Means.

14. The method of claim 10 wherein said indicator means is retrofitted to one at least keys.

15. The method of claim 10 wherein said indicator means is manufactured as an integral part of one at least keys.

16. The method of claim 15 wherein said integral is in part at least in the handle of said keys.

17. The method of claim 1 wherein operation of said electronic means is facilitated by a second means coupled by conductor means.

18. The method of claim 17 wherein said conductor means are electrical.

19. The method of claim 17 wherein said second means includes a key grouping means.

20. The method of claim 17 wherein said second means includes a key control means.

21. The method of claim 20 wherein said key control means is coupled to a key tag.

22. The method of claim 1 wherein operation of said electronic means is facilitated by a second means coupled by infrared means.

23. The method of claim 1 wherein operation of said electronic means is facilitated by a second means coupled by RF means.

24. The method of coupling an electronically readable ID means to one at least keys.

25. The method of claim 24 wherein a first ID Means is coupled to a first key and a second ID means is coupled to a second key and one at least ID means facilitates selection of said first keys from said second keys.

26. The method of claim 24 wherein said ID Means facilitates selection of one at least keys for use with one at least locks.

27. The method of claim 24 wherein said ID means facilitates determination of one at least target locks for one at least keys.

28. The method of coupling an electronically addressable memory storage means to one at least keys.

29. The method of claim 28 wherein said memory storage means includes electronically stored information describing one at least locks that said key is able to action.

30. The method of claim 29 wherein said electronically stored information is read.

31. The method of claim 29 wherein said electronically stored information is written.

32. The method of claim 28 wherein said memory storage means is included in part at least in one at least Local Key Means.

33. The method of claim 28 wherein said memory storage means is included in part at least in one at least Key Grouping Means.

34. The method of claim 28 wherein said memory storage means is included in part at least in one at least Key Control Means.

35. The method of claim 34 wherein said Key Control Means is included in part at least in one at least key tags.

36. The method of coupling a means to one at least locks wherein said means includes one at least of:—i) electronically readable Lock ID means; ii) electronically readable and/or writeable description of one at least keys that is able to action said lock(s).

37. The method of claim 36 wherein said reading and/or writing includes RFD Means.

38. The method of claim 37 wherein reading and/or writing means for said RFID means are included in part at least in one at least Key Tags and/or Key Grouping Means.

39. The method of coupling at least one electrical power conductor and/or at least one electrical return conductor to one at least Key Grouping Means.

40. The method of claim 39 wherein one at least Keys attach by an attachment means to said Key Grouping Means and interface to said one at least power conductors and/or said one at least return conductors in a manner that permits part at least of electronic means attached to said key to receive power from a power means.

41. The method of claim 40 wherein one at least said keys is reversibly attached.

42. The method of claim 40 wherein said electronic means in part at least are on the key side of the attachment means.

43. The method of claim 40 wherein part at least of said power means is attached to one at least Key Grouping Means.

44. The method of claim 40 wherein part at least of said power means is attached to one at least Key Control Means.

45. The method of claim 39 wherein one at least said conductors forms part at least of a means that transfers data and power on a single conductor.

46. The method of claim 39 wherein one at least means may move in an arc around said Key Grouping Means while maintaining one at least electrical connections to one at least said conductors.

47. The method of claim 46 wherein one at least said means is a key.

48. The method of claim 46 wherein one at least means is a Key Control Means.

49. The method of providing an electronic means that includes one at least of:—
i) means to electronically read one at least Lock ID means;
ii) memory storage means that stores one at least Lock ID means;
iii) memory storage means that stores one at least Key ID Means;
iv) memory storage means that stores one at least descriptions pertaining to one at least locks;
v) means to electrically couple to one at least Key Grouping Means;
vi) means to facilitate the activation of one at least illumination means coupled to one at least keys.

50. The method of claim 49 that also includes one at least of:—
i) microprocessor means;
ii) display means;
iii) sound output means;
iv) sound input means;
v) keyboard input means;
vi) means to reversibly attach to one at least Key Grouping Means;
vii) means to read information from one at least unattached keys;
viii) means to read information from one at least keys attached to a Key Grouping Means;
ix) secure processing means;
x) means to provide essential functions to one at least electronic accessory means.

51. The method steps of:—
a) electronically reading one at least Lock ID means; and
b) using said Lock ID to determine the electronic ID and/or electronic address of one at least keys that facilitate actioning one at least locks coupled to said Lock ID means; and
c) facilitating illumination of one at least illumination means coupled to one at least said keys.

52. The method step of electronically reading the electronic address and/or electronic ID means and/or other information coupled to one at least keys, and using part at least of said information to facilitate determination of one at least target locks actionable by said one at least keys.

53. The method of claim 52 wherein information pertaining to one at least target locks is made available to one at least humans.

54. The method of claim 52 wherein one at least said keys is not attached to a key grouping means.

55. The method of claim 52 wherein one at least keys is attached to a key grouping means.

56. The method of claim 52 wherein said other information is read electronically from a memory storage means.

57. The method of claim 56 wherein said other information includes descriptive information about i) one at least said target locks and/or ii) one at least means coupled to one at least said target locks.

58. The method of automatically attaching and/or detaching one at least keys to and/or from one at least key grouping means.
